(19) United States
(12) Patent Application Publication
(10) Pub. No.: US 2022/0232573 A1
(43) Pub. Date: Jul. 21, 2022

(54) METHOD AND APPARATUS FOR INDICATION OF UL PARAMETERS IN TCI STATE

(71) Applicant: Samsung Electronics Co., Ltd., Suwon-si (KR)

(72) Inventors: Emad N. Farag, Flanders, NJ (US); Eko Onggosanusi, Coppell, TX (US); Md. Saifur Rahman, Plano, TX (US); Dalin Zhu, Richardson, TX (US)

(21) Appl. No.: 17/647,155

(22) Filed: Jan. 5, 2022

Related U.S. Application Data
(60) Provisional application No. 63/138,205, filed on Jan. 15, 2021.
(60) Provisional application No. 63/173,883, filed on Apr. 12, 2021.
(60) Provisional application No. 63/188,796, filed on May 14, 2021.
(60) Provisional application No. 63/190,629, filed on May 19, 2021.
(60) Provisional application No. 63/230,556, filed on Aug. 6, 2021.
(60) Provisional application No. 63/275,305, filed on Nov. 3, 2021.

(51) Int. Cl. H04W 72/08; H04W 72/04; H04L 5/00

(52) U.S. Cl. CPC H04W 72/085; H04L 5/0048; H04W 72/0446

(57) ABSTRACT

Methods and apparatuses for indication of uplink (UL) parameters in a transmission configuration indicator (TCI) state. A method of operating a user equipment (UE) includes receiving configuration information for TCI states; receiving configuration information for a number of entries, wherein each of the number of entries includes an index and a number of parameters; receiving information indicating associations between indexes for the number of entries and the TCI states, respectively; and receiving a TCI state identifier (ID) for a first of the TCI states. The method further includes determining a first number of parameters associated with the first TCI state based on the configuration information for the number of entries and the information indicating associations; determining a time to apply the first number of parameters associated with the first TCI state; and transmitting UL channels, using the first number of parameters, starting at the determined time.

### CROSS-REFERENCE TO RELATED APPLICATIONS AND CLAIM OF PRIORITY

The present application claims priority to: U.S. Provisional Patent Application No. 63/138,205, filed on Jan. 15, 2021; U.S. Provisional Patent Application No. 63/173,883, filed on Apr. 12, 2021; U.S. Provisional Patent Application No. 63/188,796, filed on May 14, 2021; U.S. Provisional Patent Application No. 63/190,629, filed on May 19, 2021; U.S. Provisional Patent Application No. 63/230,556, filed on Aug. 6, 2021; and U.S. Provisional Patent Application No. 63/275,305, filed on Nov. 3, 2021. The content of the above-identified patent document is incorporated herein by reference.

### TECHNICAL FIELD

The present disclosure relates generally to wireless communication systems and, more specifically, the present disclosure relates to an indication of uplink (UL) parameters in a transmission configuration indicator (TCI) state.

### BACKGROUND

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

### SUMMARY

The present disclosure relates to wireless communication systems and, more specifically, the present disclosure relates to an indication of UL parameters and pathloss reference signal (PL-RS) induced in or associated with TCI state. The UL parameters can include power control parameters (e.g., P0, alpha (fractional pathloss compensation factor for power control) and/or power control closed loop index) and/or UL time advance (TA) offset.

In one embodiment, a user equipment (UE) is provided. The UE includes a transceiver configured to receive configuration information for TCI states, configuration information for a number of entries, wherein each of the number of entries includes an index and a number of parameters, information indicating associations between indexes for the number of entries and the TCI states, respectively, and a TCI state identifier (ID) for a first of the TCI states. The UE further includes a processor operably coupled to the transceiver. The processor is configured to determine a first number of parameters associated with the first TCI state based on the configuration information for the number of entries and the information indicating associations, and determine a time to apply the first number of parameters associated with the first TCI state. The transceiver is further configured to transmit UL channels, using the first number of parameters, starting at the determined time.

In another embodiment, a base station (BS) is provided. The BS includes a transceiver configured to transmit configuration information for TCI states, configuration information for a number of entries, wherein each of the number of entries includes an index and a number of parameters, information indicating associations between indexes for the number of entries and the TCI states, respectively, and a TCI state ID for a first of the TCI states. The BS also includes a processor operably coupled to the transceiver. The processor is configured to determine a first number of parameters associated with the first TCI state, and determine a time to apply the first number of parameters associated with the first TCI state. The transceiver is further configured to receive UL channels, based on the first number of parameters, starting at the determined time.

In yet another embodiment, a method of operating a UE is provided. The method includes receiving configuration information for TCI states; receiving configuration information for a number of entries, wherein each of the number of entries includes an index and a number of parameters; receiving information indicating associations between indexes for the number of entries and the TCI states, respectively; and receiving a TCI state ID for a first of the TCI states. The method further includes determining a first number of parameters associated with the first TCI state based on the configuration information for the number of entries and the information indicating associations; determining a time to apply the first number of parameters associated with the first TCI state; and transmitting UL channels, using the first number of parameters, starting at the determined time.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example of wireless network according to embodiments of the present disclosure;

FIG. 2 illustrates an example of gNB according to embodiments of the present disclosure;

FIG. 3 illustrates an example of UE according to embodiments of the present disclosure;

FIGS. 4 and 5 illustrate example of wireless transmit and receive paths according to this disclosure;

FIG. 6A illustrate an example of wireless system beam according to embodiments of the present disclosure;

FIG. 6B illustrate an example of multi-beam operation according to embodiments of the present disclosure;

FIG. 7 illustrate an example of antenna structure according to embodiments of the present disclosure;

FIG. 8 illustrates an example of TCI state and QCL information according to embodiments of the present disclosure;

FIG. 9 illustrates an example of TCI state according to embodiments of the present disclosure;

FIG. 10 illustrates an example of QCL information according to embodiments of the present disclosure;

FIG. 11 illustrates an example of QCL type according to embodiments of the present disclosure;

FIG. 12 illustrates another example of QCL type according to embodiments of the present disclosure;

FIG. 13 illustrates an example of determination of UL parameters in TCI state according to embodiments of the present disclosure;

FIG. 14 illustrates an example of TCI state according to embodiments of the present disclosure;

FIG. 15 illustrates an example of QCL information according to embodiments of the present disclosure;

FIG. 16 illustrates an example of TCI state and QCL information according to embodiments of the present disclosure;

FIG. 17 illustrates an example of QCL information according to embodiments of the present disclosure;

FIG. 18 illustrates an example of TCI state and QCL information according to embodiments of the present disclosure;

FIG. 19 illustrates an example of QCL information according to embodiments of the present disclosure;

FIG. 20 illustrates an example of TCI state and QCL information according to embodiments of the present disclosure;

FIG. 21 illustrates an example of QCL information according to embodiments of the present disclosure;

FIG. 22 illustrates an example of TCI state and QCL information according to embodiments of the present disclosure;

FIG. 23 illustrates an example of QCL information according to embodiments of the present disclosure;

FIG. 24 illustrates an example of TCI state and QCL information according to embodiments of the present disclosure;

FIG. 25 illustrates an example of QCL information according to embodiments of the present disclosure;

FIG. 26 illustrates an example of TCI state and QCL information according to embodiments of the present disclosure;

FIG. 27 illustrates an example of QCL information according to embodiments of the present disclosure;

FIG. 28 illustrates an example of TCI state and QCL information according to embodiments of the present disclosure;

FIG. 29 illustrates an example of QCL information according to embodiments of the present disclosure;

FIG. 30 illustrates an example of MAC CE PDU according to embodiments of the present disclosure;

FIG. 31 illustrates another example of MAC CE PDU according to embodiments of the present disclosure;

FIG. 32 illustrates yet another example of MAC CE PDU according to embodiments of the present disclosure;

FIG. 33 illustrates yet another example of MAC CE PDU according to embodiments of the present disclosure;

FIG. 34 illustrates an example of reference signals according to embodiments of the present disclosure;

FIG. 35 illustrates another example of reference signals according to embodiments of the present disclosure;

FIG. 36 illustrates yet another example of reference signals according to embodiments of the present disclosure;

FIG. 37 illustrates another example of reference signals according to embodiments of the present disclosure;

FIG. 38 illustrates an example of spatial domain source reference signal according to embodiments of the present disclosure;

FIG. 39 illustrates another example of spatial domain source reference signal according to embodiments of the present disclosure;

FIG. 40 illustrates yet another example of spatial domain source reference signal according to embodiments of the present disclosure;

FIG. 41 illustrates yet another example of spatial domain source reference signal according to embodiments of the present disclosure; and

FIG. 42 illustrates a flowchart for a method for indication of UL parameters in a TCI state according to embodiments of the present disclosure.

### DETAILED DESCRIPTION

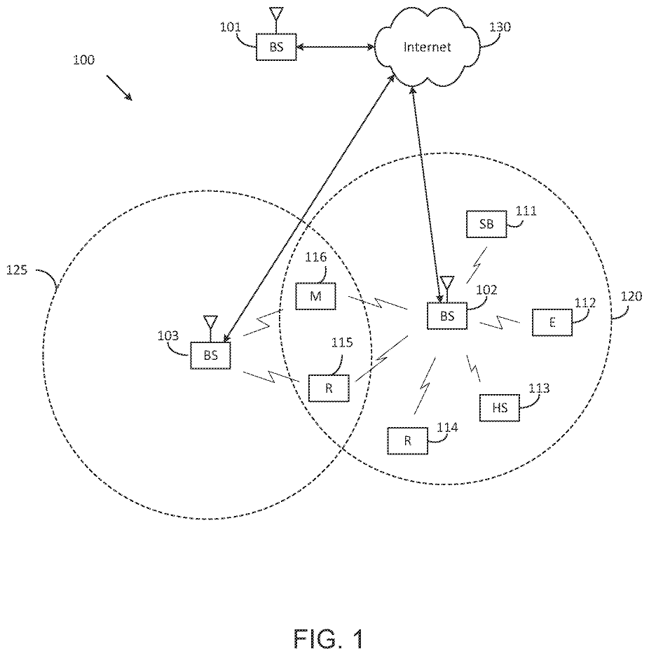

FIG. 1 through FIG. 42, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

The following documents are hereby incorporated by reference into the present disclosure as if fully set forth herein: 3GPP TS 38.211 v16.7.0, “NR; Physical channels and modulation”; 3GPP TS 38.212 v16.7.0, “NR; Multiplexing and Channel coding”; 3GPP TS 38.213 v16.7.0, “NR; Physical Layer Procedures for Control”; 3GPP TS 38.214 v16.7.0, “NR; Physical Layer Procedures for Data”; 3GPP TS 38.321 v16.6.0, “NR; Medium Access Control (MAC) protocol specification”; and 3GPP TS 38.331 v16.6.0, “NR; Radio Resource Control (RRC) Protocol Specification.”

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably-arranged communications system.

FIG. 1 illustrates an example wireless network according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise (E); a UE 113, which may be located in a WiFi hotspot (HS); a UE 114, which may be located in a first residence (R); a UE 115, which may be located in a second residence (R); and a UE 116, which may be a mobile device (M), such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3GPP NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, for an indication of UL parameters in TCI state. In certain embodiments, and one or more of the gNBs 101-103 includes circuitry, programing, or a combination thereof, for an indication or association of UL parameters and/or PL-RS in or with TCI state.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

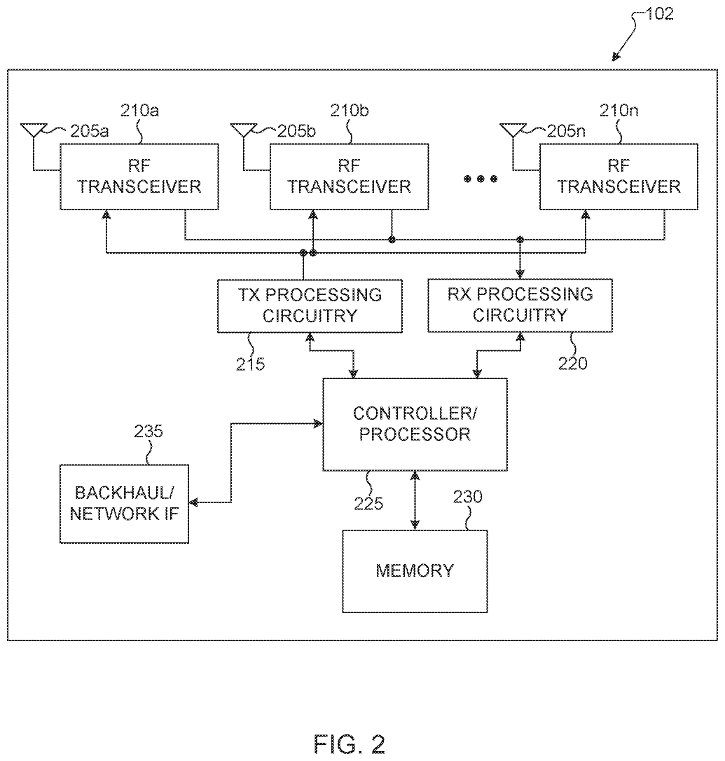

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple RF transceivers 210a-210n, transmit (TX) processing circuitry 215, and receive (RX) processing circuitry 220. The gNB 102 also includes a controller/processor 225, a memory 230, and a backhaul or network interface 235.

The RF transceivers 210a-210n receive, from the antennas 205a-205n, incoming RF signals, such as signals transmitted by UEs in the network 100. The RF transceivers 210a-210n down-convert the incoming RF signals to generate IF or baseband signals. The IF or baseband signals are sent to the RX processing circuitry 220, which generates processed baseband signals by filtering, decoding, and/or digitizing the baseband or IF signals. The RX processing circuitry 220 transmits the processed baseband signals to the controller/processor 225 for further processing.

The TX processing circuitry 215 receives analog or digital data (such as voice data, web data, e-mail, or interactive video game data) from the controller/processor 225. The TX processing circuitry 215 encodes, multiplexes, and/or digitizes the outgoing baseband data to generate processed baseband or IF signals. The RF transceivers 210a-210n receive the outgoing processed baseband or IF signals from the TX processing circuitry 215 and up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of UL channel signals and the transmission of DL channel signals by the RF transceivers 210a-210n, the RX processing circuitry 220, and the TX processing circuitry 215 in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as an OS. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or RF transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. As a particular example, an access point could include a number of interfaces 235, and the controller/processor 225 could support routing functions to route data between different network addresses. As another particular example, while shown as including a single instance of TX processing circuitry 215 and a single instance of RX processing circuitry 220, the gNB 102 could include multiple instances of each (such as one per RF transceiver). Also, various components in FIG. 2 could be combined, further subdivided, or omitted and additional components could be added according to particular needs.

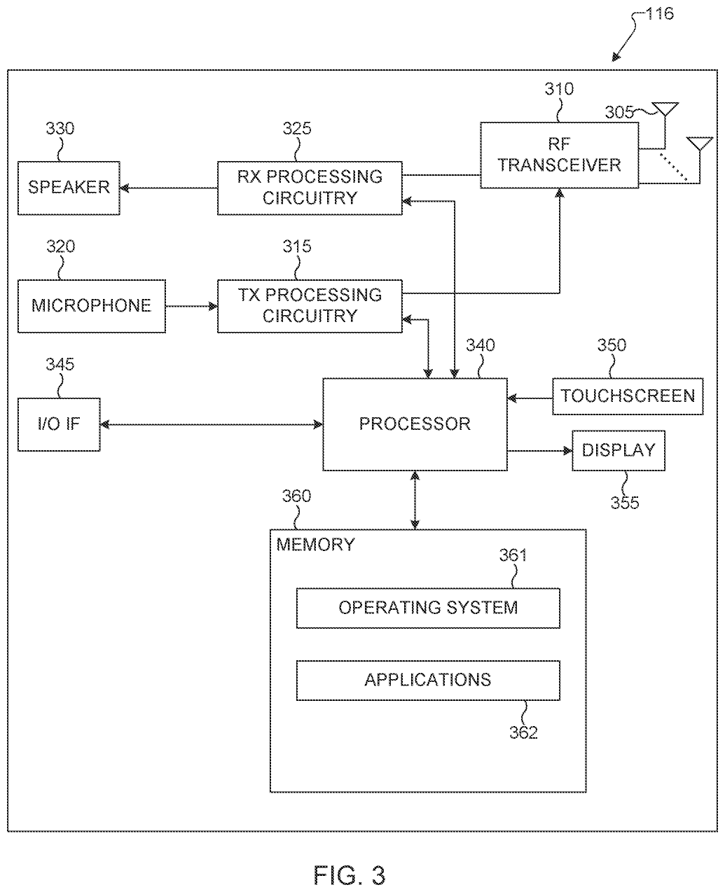

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes an antenna 305, a radio frequency (RF) transceiver 310, TX processing circuitry 315, a microphone 320, and receive (RX) processing circuitry 325. The UE 116 also includes a speaker 330, a processor 340, an input/output (I/O) interface (IF) 345, a touchscreen 350, a display 355, and a memory 360. The memory 360 includes an operating system (OS) 361 and one or more applications 362.

The RF transceiver 310 receives, from the antenna 305, an incoming RF signal transmitted by a gNB of the network 100. The RF transceiver 310 down-converts the incoming RF signal to generate an intermediate frequency (IF) or baseband signal. The IF or baseband signal is sent to the RX processing circuitry 325, which generates a processed baseband signal by filtering, decoding, and/or digitizing the baseband or IF signal. The RX processing circuitry 325 transmits the processed baseband signal to the speaker 330 (such as for voice data) or to the processor 340 for further processing (such as for web browsing data).

The TX processing circuitry 315 receives analog or digital voice data from the microphone 320 or other outgoing baseband data (such as web data, e-mail, or interactive video game data) from the processor 340. The TX processing circuitry 315 encodes, multiplexes, and/or digitizes the outgoing baseband data to generate a processed baseband or IF signal. The RF transceiver 310 receives the outgoing processed baseband or IF signal from the TX processing circuitry 315 and up-converts the baseband or IF signal to an RF signal that is transmitted via the antenna 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the RF transceiver 310, the RX processing circuitry 325, and the TX processing circuitry 315 in accordance with well-known principles. In some embodiments, the processor 340 includes at least one microprocessor or microcontroller.

The processor 340 is also capable of executing other processes and programs resident in the memory 360, such as processes for an indication or association of UL parameters and/or PL-RS in or with TCI state. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the touchscreen 350 and the display 355. The operator of the UE 116 can use the touchscreen 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). Also, while FIG. 3 illustrates the UE 116 configured as a mobile telephone or smartphone, UEs could be configured to operate as other types of mobile or stationary devices.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancellation and the like.

The discussion of 5G systems and frequency bands associated therewith is for reference as certain embodiments of the present disclosure may be implemented in 5G systems. However, the present disclosure is not limited to 5G systems or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

The discussion of 5G systems and frequency bands associated therewith is for reference as certain embodiments of the present disclosure may be implemented in 5G systems. However, the present disclosure is not limited to 5G systems or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

A communication system includes a downlink (DL) that refers to transmissions from a base station or one or more transmission points to UEs and an uplink (UL) that refers to transmissions from UEs to a base station or to one or more reception points.

A time unit for DL signaling or for UL signaling on a cell is referred to as a slot and can include one or more symbols. A symbol can also serve as an additional time unit. A frequency (or bandwidth (BW)) unit is referred to as a resource block (RB). One RB includes a number of sub-carriers (SCs). For example, a slot can have duration of 0.5 milliseconds or 1 millisecond, include 14 symbols and an RB can include 12 SCs with inter-SC spacing of 30 KHz or 15 KHz, and so on.

DL signals include data signals conveying information content, control signals conveying DL control information (DCI), and reference signals (RS) that are also known as pilot signals. A gNB transmits data information or DCI through respective physical DL shared channels (PDSCHs) or physical DL control channels (PDCCHs). A PDSCH or a PDCCH can be transmitted over a variable number of slot symbols including one slot symbol. For brevity, a DCI format scheduling a PDSCH reception by a UE is referred to as a DL DCI format and a DCI format scheduling a physical uplink shared channel (PUSCH) transmission from a UE is referred to as an UL DCI format.

A gNB transmits one or more of multiple types of RS including channel state information RS (CSI-RS) and demodulation RS (DMRS). A CSI-RS is primarily intended for UEs to perform measurements and provide CSI to a gNB. For channel measurement, non-zero power CSI-RS (NZP CSI-RS) resources are used. For interference measurement reports (IMRs), CSI interference measurement (CSI-IM) resources associated with a zero power CSI-RS (ZP CSI-RS) configuration are used. A CSI process includes NZP CSI-RS and CSI-IM resources.

A UE can determine CSI-RS transmission parameters through DL control signaling or higher layer signaling, such as radio resource control (RRC) signaling, from a gNB. Transmission instances of a CSI-RS can be indicated by DL control signaling or be configured by higher layer signaling. A DM-RS is transmitted only in the BW of a respective PDCCH or PDSCH and a UE can use the DMRS to demodulate data or control information.

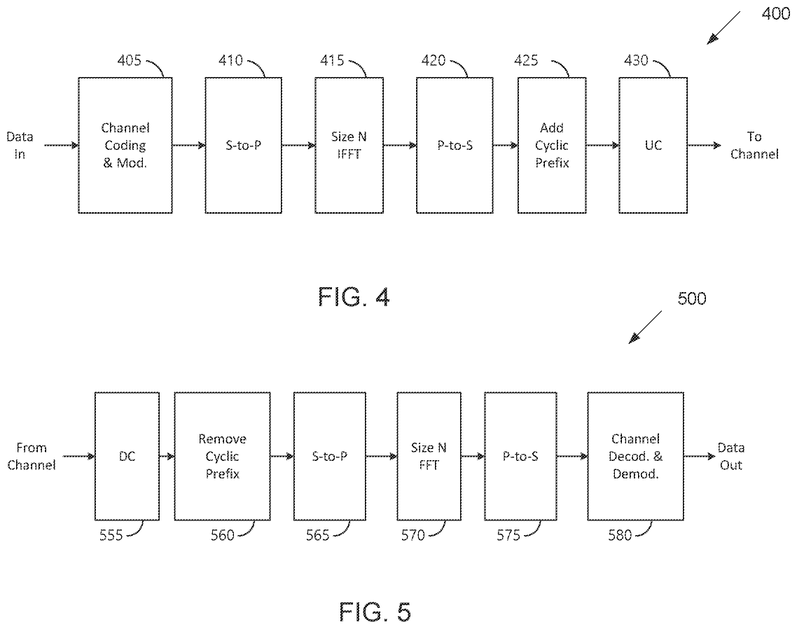

FIG. 4 and FIG. 5 illustrate example wireless transmit and receive paths according to this disclosure. In the following description, a transmit path 400 may be described as being implemented in a gNB (such as the gNB 102), while a receive path 500 may be described as being implemented in a UE (such as a UE 116). However, it may be understood that the receive path 500 can be implemented in a gNB and that the transmit path 400 can be implemented in a UE. In some embodiments, the receive path 500 is configured to support the codebook design and structure for systems having 2D antenna arrays as described in embodiments of the present disclosure.

The transmit path 400 as illustrated in FIG. 4 includes a channel coding and modulation block 405, a serial-to-parallel (S-to-P) block 410, a size N inverse fast Fourier transform (IFFT) block 415, a parallel-to-serial (P-to-S) block 420, an add cyclic prefix block 425, and an up-converter (UC) 430. The receive path 500 as illustrated in FIG. 5 includes a down-converter (DC) 555, a remove cyclic prefix block 560, a serial-to-parallel (S-to-P) block 565, a size N fast Fourier transform (FFT) block 570, a parallel-to-serial (P-to-S) block 575, and a channel decoding and demodulation block 580.

As illustrated in FIG. 4, the channel coding and modulation block 405 receives a set of information bits, applies coding (such as a low-density parity check (LDPC) coding), and modulates the input bits (such as with quadrature phase shift keying (QPSK) or quadrature amplitude modulation (QAM)) to generate a sequence of frequency-domain modulation symbols.

The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to an RF frequency for transmission via a wireless channel. The signal may also be filtered at baseband before conversion to the RF frequency.

A transmitted RF signal from the gNB 102 arrives at the UE 116 after passing through the wireless channel, and reverse operations to those at the gNB 102 are performed at the UE 116.

As illustrated in FIG. 5, the down-converter 555 down-converts the received signal to a baseband frequency, and the remove cyclic prefix block 560 removes the cyclic prefix to generate a serial time-domain baseband signal. The serial-to-parallel block 565 converts the time-domain baseband signal to parallel time domain signals. The size N FFT block 570 performs an FFT algorithm to generate N parallel frequency-domain signals. The parallel-to-serial block 575 converts the parallel frequency-domain signals to a sequence of modulated data symbols. The channel decoding and demodulation block 580 demodulates and decodes the modulated symbols to recover the original input data stream.

Each of the gNBs 101-103 may implement a transmit path 400 as illustrated in FIG. 4 that is analogous to transmitting in the downlink to UEs 111-116 and may implement a receive path 500 as illustrated in FIG. 5 that is analogous to receiving in the uplink from UEs 111-116. Similarly, each of UEs 111-116 may implement the transmit path 400 for transmitting in the uplink to the gNBs 101-103 and may implement the receive path 500 for receiving in the downlink from the gNBs 101-103.

Each of the components in FIG. 4 and FIG. 5 can be implemented using only hardware or using a combination of hardware and software/firmware. As a particular example, at least some of the components in FIGS. 4 and FIG. 5 may be implemented in software, while other components may be implemented by configurable hardware or a mixture of software and configurable hardware. For instance, the FFT block 570 and the IFFT block 515 may be implemented as configurable software algorithms, where the value of size N may be modified according to the implementation.

Furthermore, although described as using FFT and IFFT, this is by way of illustration only and may not be construed to limit the scope of this disclosure. Other types of transforms, such as discrete Fourier transform (DFT) and inverse discrete Fourier transform (IDFT) functions, can be used. It may be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIG. 4 and FIG. 5 illustrate examples of wireless transmit and receive paths, various changes may be made to FIG. 4 and FIG. 5. For example, various components in FIG. 4 and FIG. 5 can be combined, further subdivided, or omitted and additional components can be added according to particular needs. Also, FIG. 4 and FIG. 5 are meant to illustrate examples of the types of transmit and receive paths that can be used in a wireless network. Any other suitable architectures can be used to support wireless communications in a wireless network.

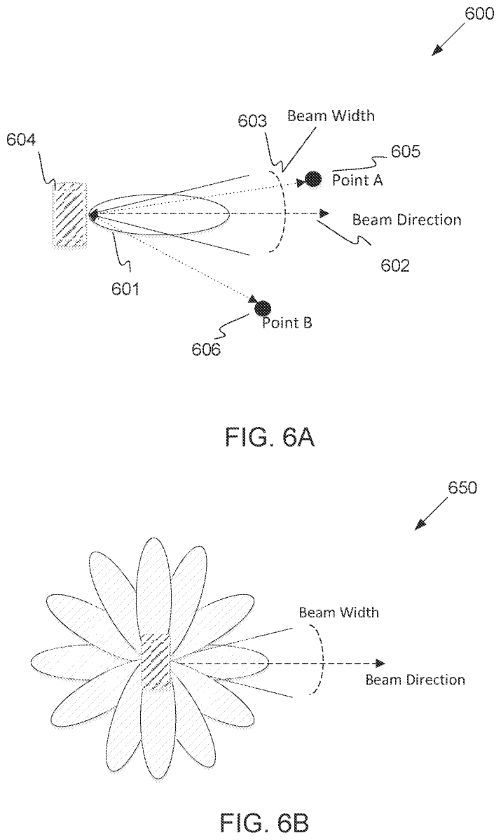

FIG. 6A illustrate an example wireless system beam 600 according to embodiments of the present disclosure. An embodiment of the wireless system beam 600 shown in FIG. 6A is for illustration only.

As illustrated in FIG. 6A, in a wireless system a beam 601, for a device 604, can be characterized by a beam direction 602 and a beam width 603. For example, a device 604 with a transmitter transmits radio frequency (RF) energy in a beam direction and within a beam width. The device 604 with a receiver receives RF energy coming towards the device in a beam direction and within a beam width. As illustrated in FIG. 6A, a device at point A 605 can receive from and transmit to the device 604 as Point A is within a beam width of a beam traveling in a beam direction and coming from the device 604.

As illustrated in FIG. 6A, a device at point B 606 cannot receive from and transmit to the device 604 as Point B is outside a beam width of a beam traveling in a beam direction and coming from the device 604. While FIG. 6A, for illustrative purposes, shows a beam in 2-dimensions (2D), it may be apparent to those skilled in the art, that a beam can be in 3-dimensions (3D), where the beam direction and beam width are defined in space.

FIG. 6B illustrate an example multi-beam operation 650 according to embodiments of the present disclosure. An embodiment of the multi-beam operation 650 shown in FIG. 6B is for illustration only.

In a wireless system, a device can transmit and/or receive on multiple beams. This is known as “multi-beam operation” and is illustrated in FIG. 6B. While FIG. 6B, for illustrative purposes, is in 2D, it may be apparent to those skilled in the art, that a beam can be 3D, where a beam can be transmitted to or received from any direction in space.

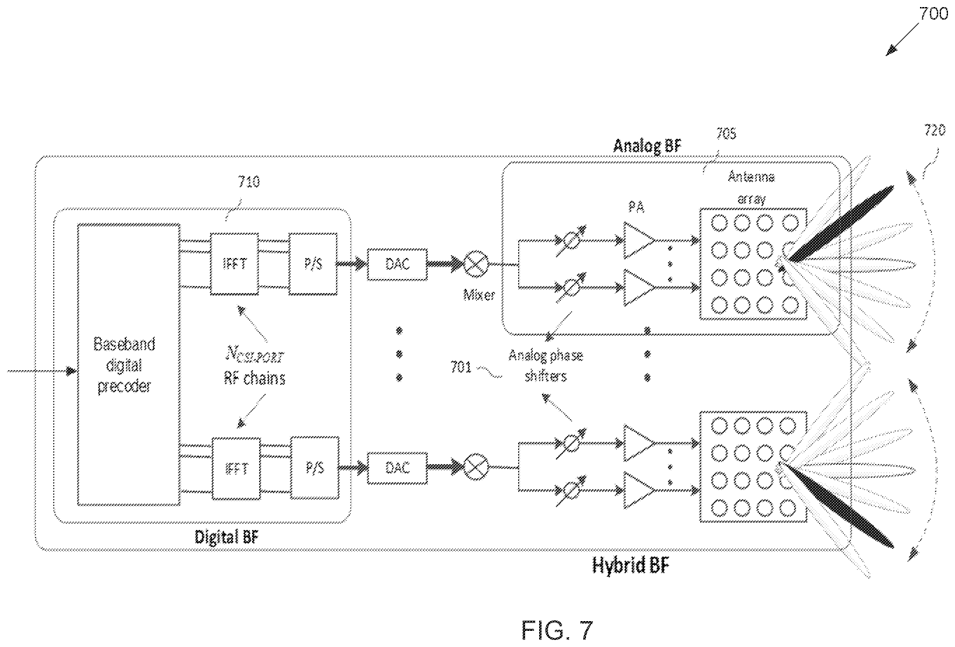

Rel.14 LTE and Rel.15 NR support up to 32 CSI-RS antenna ports which enable an eNB to be equipped with a large number of antenna elements (such as 64 or 128). In this case, a plurality of antenna elements is mapped onto one CSI-RS port. For mmWave bands, although the number of antenna elements can be larger for a given form factor, the number of CSI-RS ports—which can correspond to the number of digitally precoded ports—tends to be limited due to hardware constraints (such as the feasibility to install a large number of ADCs/DACs at mmWave frequencies) as illustrated in FIG. 7.

FIG. 7 illustrate an example antenna structure 700 according to embodiments of the present disclosure. An embodiment of the antenna structure 700 shown in FIG. 7 is for illustration only.

In this case, one CSI-RS port is mapped onto a large number of antenna elements which can be controlled by a bank of analog phase shifters 701. One CSI-RS port can then correspond to one sub-array which produces a narrow analog beam through analog beamforming 705. This analog beam can be configured to sweep across a wider range of angles 720 by varying the phase shifter bank across symbols or subframes. The number of sub-arrays (equal to the number of RF chains) is the same as the number of CSI-RS ports N_{CSI-PORT}. A digital beamforming unit 710 performs a linear combination across N_{CSI-PORT} analog beams to further increase precoding gain. While analog beams are wideband (hence not frequency-selective), digital precoding can be varied across frequency sub-bands or resource blocks. Receiver operation can be conceived analogously.

Since the aforementioned system utilizes multiple analog beams for transmission and reception (wherein one or a small number of analog beams are selected out of a large number, for instance, after a training duration—to be performed from time to time), the term “multi-beam operation” is used to refer to the overall system aspect. This includes, for the purpose of illustration, indicating the assigned DL or UL TX beam (also termed “beam indication”), measuring at least one reference signal for calculating and performing beam reporting (also termed “beam measurement” and “beam reporting”, respectively), and receiving a DL or UL transmission via a selection of a corresponding RX beam.

The aforementioned system is also applicable to higher frequency bands such as >52.6 GHz. In this case, the system can employ only analog beams. Due to the O2 absorption loss around 60 GHz frequency (˜10 dB additional loss @100 m distance), larger number of and sharper analog beams (hence larger number of radiators in the array) may be needed to compensate for the additional path loss.

Rel-17 introduced the unified TCI framework, where a unified or master or main TCI state is signaled to the UE. The unified or master or main TCI state can be one of: (1) in case of joint TCI state indication, wherein a same beam is used for DL and UL channels, a joint TCI state that can be used at least for UE-dedicated DL channels and UE-dedicated UL channels; (2) in case of separate TCI state indication, wherein different beams are used for DL and UL channels, a DL TCI state that can be used at least for UE-dedicated DL channels; and/or (3) in case of separate TCI state indication, wherein different beams are used for DL and UL channels, a UL TCI state that can be used at least for UE-dedicated UL channels.

The unified (master or main) TCI state is TCI state of UE-dedicated reception on PDSCH/PDCCH or UE-dedicated transmission on dynamic-grant/configured-grant based PUSCH and all of dedicated PUCCH resources.

The unified TCI framework applies to intra-cell beam management, wherein, the TCI states have a source RS that is directly or indirectly associated (as described in component 4), through a quasi-co-location relation, e.g., spatial relation, with an SSB of a serving cell. The unified TCI state framework also applies to inter-cell beam management, wherein a TCI state can have a source RS that is directly or indirectly associated, through a quasi-co-location relation, e.g., spatial relation, with an SSB of cell that has a PCI different from the PCI of the serving cell.

A quasi-co-location (QCL) relation can be quasi-location with respect to one or more of the following relations: (1) Type A, {Doppler shift, Doppler spread, average delay, delay spread}; (2) Type B, {Doppler shift, Doppler spread}; (3) Type C, {Doppler shift, average delay}; and/or (4) Type D, {Spatial Rx parameter}.

In addition, quasi-co-location relation can also provide a spatial relation for UL channels, e.g., a DL source reference signal provides information on the spatial domain filter to be used for UL transmissions, or the UL source reference signal provides the spatial domain filter to be used for UL transmissions, e.g., same spatial domain filter for UL source reference signal and UL transmissions.

The unified (master or main) TCI state applies at least to UE dedicated DL and UL channels. The unified (master or main) TCI can also apply to other DL and/or UL channels and/or signals e.g., non-UE dedicated channel and sounding reference signal (SRS).

The present disclosure provides signaling mechanisms for UL transmission related parameters associated with or linked to a TCI state: (1) signaling of a PL-RS associated with or linked to a TCI State; and/or (2) signaling of UL parameters that are associated with, linked to or depend on a TCI state. UL parameters can include for example, additional UL timing offset, UL power control parameters such as P0, alpha (fractional pathloss compensation factor for power control) and power control closed loop (CL) index.

In release 15/16 a common framework is shared for CSI and beam management, while the complexity of such framework is justified for CSI in FR1, the common framework makes beam management procedures rather cumbersome, and less efficient in FR2. Efficiency here refers to overhead associated with beam management operations and latency for reporting and indicating new beams.

Furthermore, in release 15 and release 16, the beam management framework is different for different channels. This increases the overhead of beam management, and could lead to less robust beam-based operation. For example, for PDCCH the TCI state (used for beam indication), is updated through MAC CE signaling. While the TCI state of PDSCH can updated through a DL DCI carrying the DL assignment with codepoints configured by MAC CE, or the PDSCH TCI state can follow that of the corresponding PDCCH, or use a default beam indication. In the uplink direction, the spatialRelationInfo framework is used for beam indication for PUCCH and SRS, which is updated through RRC and MAC CE signaling.

For PUSCH the SRI (SRS Resource Indicator), in an UL DCI with UL grants, can be used for beam indication. Having different beam indications and beam indication update mechanisms increases the complexity, overhead and latency of beam management, and could lead to less robust beam-based operation.

To reduce the latency and overhead of beam indication, an L1 based beam indication has been provided, with a common framework for DL and UL TCI state indication. A TCI state can be a joint TCI state for DL and UL beam indication or separate DL and UL TCI state indications can be used for DL and UL beam indication. For UL beam indication, UL transmission related parameters and PL-RS are to be included in or associated with the TCI state. The present disclosure provides signaling mechanisms for pathloss RS and UL transmission related parameters associated with the TCI state.

In the present disclosure, both FDD and TDD are considered as a duplex method for DL and UL signaling. Although exemplary descriptions and embodiments to follow assume orthogonal frequency division multiplexing (OFDM) or orthogonal frequency division multiple access (OFDMA), the present disclosure can be extended to other OFDM-based transmission waveforms or multiple access schemes such as filtered OFDM (F-OFDM).

The present disclosure considers several components that can be used in conjunction or in combination with one another, or can operate as standalone schemes.

In the present disclosure, the term “activation” describes an operation wherein a UE receives and decodes a signal from the network (or gNB) that signifies a starting point in time. The starting point can be a present or a future slot/subframe or symbol and the exact location is either implicitly or explicitly indicated, or is otherwise specified in the system operation or is configured by higher layers. Upon successfully decoding the signal, the UE responds according to an indication provided by the signal. The term “deactivation” describes an operation wherein a UE receives and decodes a signal from the network (or gNB) that signifies a stopping point in time. The stopping point can be a present or a future slot/subframe or symbol and the exact location is either implicitly or explicitly indicated, or is otherwise specified in the system operation or is configured by higher layers. Upon successfully decoding the signal, the UE responds according to an indication provided by the signal.

Terminology such as TCI, TCI states, SpatialRelationInfo, target RS, reference RS, and other terms is used for illustrative purposes and is therefore not normative. Other terms that refer to same functions can also be used.

In any of the following components, examples and sub-examples, flowcharts and diagrams maybe used for illustrative purposes. The present disclosure covers any possible variation of the flowcharts and diagrams as long as at least some of the components are included.

In the following components, a TCI state is used for beam indication. The TCI can refer to a DL TCI state for downlink channels (e.g., PDCCH and PDSCH), an uplink TCI state for uplink channels (e.g., PUSCH or PUCCH), a joint TCI state for downlink and uplink channels, or separate TCI states for uplink and downlink channels. A TCI state can be common across multiple component carriers or can be a separate TCI state for a component carrier or a set of component carriers. A TCI state can be gNB or UE panel specific or common across panels. In some examples, the uplink TCI state can be replaced by SRS resource indicator (SRI).

A TCI state can be a joint TCI state, wherein the TCI state indicates a reference signal for DL and UL spatial filter determination. Alternatively, for DL and UL beam indication, a separate DL TCI state and a separate UL TCI state are used respectively. An UL TCI state or a joint TCI state can include or is associated with or linked to a reference signal for pathloss estimation.

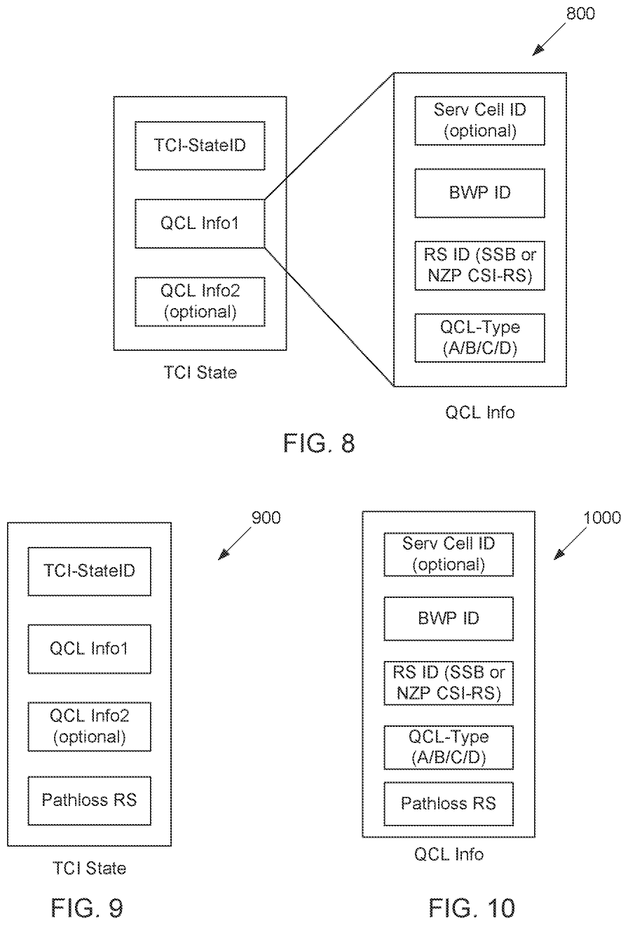

In Rel-15 and Rel-16, a TCI state includes (as shown in FIG. 8): (1) a TCI state ID; and (2) one or two QCL Info Information Elements (IEs). Wherein, the QCL-Type can be: (i) QCL-TypeA {Doppler shift, Doppler spread, average delay, delay spread}; (ii) QCL-TypeB {Doppler shift, Doppler spread}; (iii) QCL-TypeC {Doppler shift, average delay}; and/or (iv) QCL-TypeD {Spatial Rx Parameter} (e.g., for spatial filter determination).

FIG. 8 illustrates an example of TCI state and QCL information 800 according to embodiments of the present disclosure. An embodiment of the TCI state and QCL information 800 shown in FIG. 8 is for illustration only.

In one example 1.1, a TCI state can include a pathloss RS.

In one example 1.1.1, a TCI state can include a pathloss RS as shown in FIG. 9. The presence of pathloss RS IE can be optional (e.g., it can be absent) and may not be included, or the pathloss RS IE is always present and can be set to a default dummy value (when not used). Optionally, the presence or absence of the pathloss RS IE can be configured.

FIG. 9 illustrates an example of TCI state 900 according to embodiments of the present disclosure. An embodiment of the TCI state 900 shown in FIG. 9 is for illustration only.

In one example 1.1.1A, a QCL info can include a pathloss RS as shown in FIG. 10. The presence of pathloss RS IE can be optional (e.g., it can be absent) and may not be included, or the pathloss RS IE is always present and can be set to a default dummy value (when not used). Optionally, the presence or absence of the pathloss RS IE can be configured.

FIG. 10 illustrates an example of QCL information 1000 according to embodiments of the present disclosure. An embodiment of the QCL information 1000 shown in FIG. 10 is for illustration only.

In another example 1.1.2, the pathloss RS can be indicated by an RS-ID indicated by a QCL type in the TCI state.

In one example 1.1.2.1, the pathloss RS can be indicated by the RS-ID of the QCL Info with QCL-Type D.

In another example 1.1.2.2, the pathloss RS can be indicated by the RS-ID of the QCL info with QCL-Type A or B or C.

In another example 1.1.2.3, if the TCI state includes only one QCL Info IE, the pathloss RS can be indicated by the RS-ID of the QCL info IE included in the TCI state.

In another example 1.1.2.3a, if the TCI state includes only one QCL Info IE (QCL-info1), i.e., the second QCL Info (QCL-info2) is absent, but the IE for the QCL-info2 can be used for the pathloss RS.

In another example 1.1.2.4, if the TCI state includes two QCL Info IEs, the QCL Info IE including the pathloss RS can be configured by RRC signaling and/or MAC CE signaling and/or L1 control signaling, and the pathloss RS can be indicated by the RS-ID of the configured QCL info IE.

In another example 1.1.2.4a, if the TCI state includes two QCL Info IEs, the pathloss RS can be indicated by the RS-ID of the first QCL info IE (QCL-info1) included in the TCI state.

In another example 1.1.2.4b, if the TCI state includes two QCL Info IEs, the pathloss RS can be indicated by the RS-ID of the second QCL info IE (QCL-info2) included in the TCI state.

In another example 1.1.3, a new QCL-Type is defined, e.g., QCL-Type E, for indicating a pathloss RS.

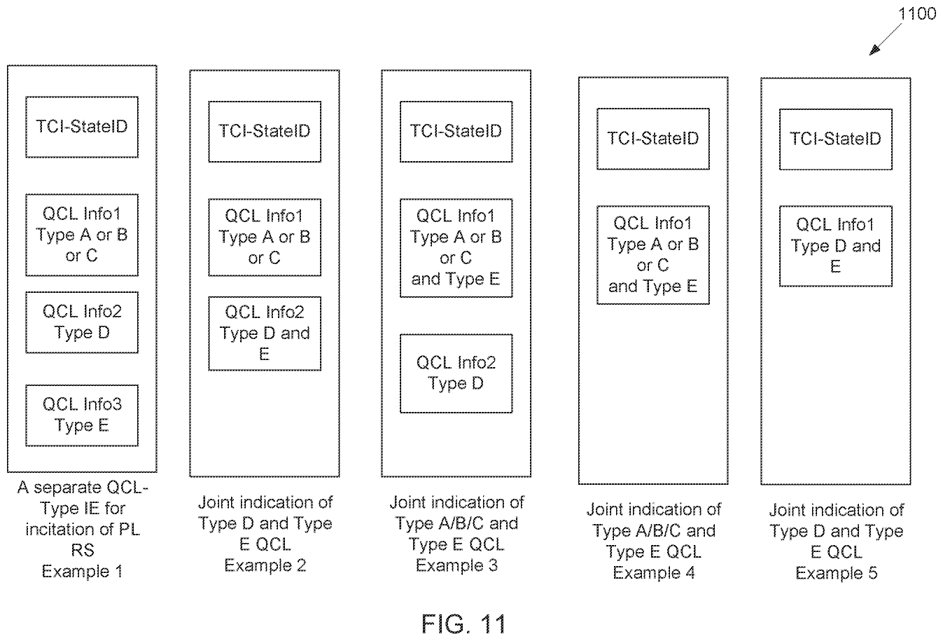

FIG. 11 illustrates an example of QCL type 1100 according to embodiments of the present disclosure. An embodiment of the QCL type 1100 shown in FIG. 11 is for illustration only.

In one example 1.1.3.1 (Example 1 of FIG. 11), a pathloss RS is indicated by including a third QCL Info IE in the TCI state, wherein a third QCL info can be of QCL-Type E, i.e., quasi-co-location with respect to pathloss.

In another example 1.1.3.2 (Example 2 of FIG. 11), a pathloss RS is indicated by QCL info of QCL-Type D, i.e., QCL Type-D also indicates QCL Type-E, whether by system specification or by network configuration. The TCI state includes two QCL Info IEs.

In another example 1.1.3.3 (Example 3 of FIG. 11), a pathloss RS is indicated by QCL info of QCL-Type A or B or C, i.e., QCL Type-A or B or C also indicates QCL Type-E, whether by system specification or by network configuration. The TCI state includes two QCL Info IE.

In another example 1.1.3.4 (Example 4 of FIG. 11), a pathloss RS is indicated by QCL info of QCL-Type A or B or C, i.e., QCL Type-A or B or C also indicates QCL Type-E, whether by system specification or by network configuration. The TCI state includes one QCL Info IE.

In another example 1.1.3.5 (Example 5 of FIG. 11), a pathloss RS is indicated by QCL info of QCL-Type D, i.e., QCL Type-D also indicates QCL Type-E, whether by system specification or by network configuration. The TCI state includes one QCL Info IE.

In another example 1.1.4, new QCL-Types are defined, for indicating a pathloss RS: (1) QCL-TypeE {Pathloss}; (2) QCL-TypeF {Doppler shift, Doppler spread, average delay, delay spread, Pathloss}, (3) QCL-TypeG {Doppler shift, Doppler spread, pathloss}; (4) QCL-TypeH {Doppler shift, average delay, pathloss}; and/or (5) QCL-TypeI {Spatial Rx Parameter, pathloss}.

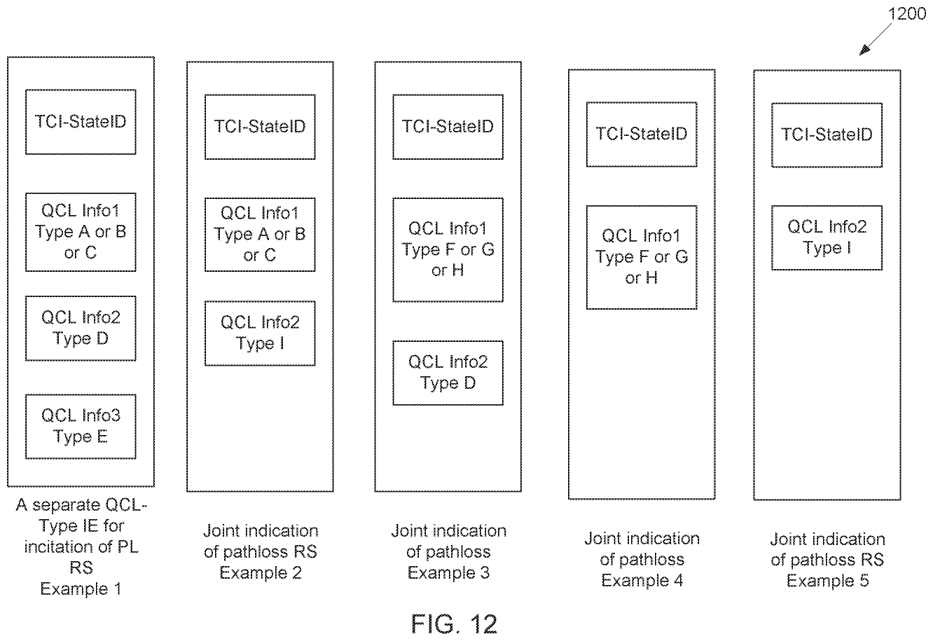

FIG. 12 illustrates another example of QCL type 1200 according to embodiments of the present disclosure. An embodiment of the QCL type 1200 shown in FIG. 12 is for illustration only.

In one example 1.1.4.1 (Example 1 of FIG. 12), a pathloss RS is indicated by including a third QCL Info IE in the TCI state, wherein a third QCL info can be of QCL-Type E, i.e., quasi-co-location with respect to pathloss.

In another example 1.1.4.2 (Example 2 of FIG. 12), a pathloss RS is indicated by QCL info of QCL-Type I, indicating an RS for quasi-co-location with respect to spatial Rx parameters and pathloss. The TCI state includes two QCL Info IEs.

In another example 1.1.4.3 (Example 3 of FIG. 12), a pathloss RS is indicated by QCL info of QCL-Type F or G or H, indicating an RS for quasi-co-location with respect to pathloss and one or more of {Doppler shift, Doppler spread, average delay, delay spread}. The TCI state includes two QCL Info IEs.

In another example 1.1.4.4 (Example 4 of FIG. 12), a pathloss RS is indicated by QCL info of QCL-Type A or B or C, indicating an RS for quasi-co-location with respect to pathloss and one or more of {Doppler shift, Doppler spread, average delay, delay spread}. The TCI state includes one QCL Info IE.

In another example 1.1.4.5 (Example 5 of FIG. 12), a pathloss RS is indicated by QCL info of QCL-Type I, indicating an RS for quasi-co-location with respect to spatial Rx parameters and pathloss. The TCI state includes one QCL Info IE.

In another example 1.2, a TCI state can implicitly include a pathloss RS.

In one example 1.2.1, the pathloss RS can be determined by the RS-ID of the QCL Info with QCL-Type D.

In one example 1.2.1.1, if the source RS of QCL-Type D or spatial relation is a DL periodic RS (e.g., synchronization signal/physical broadcast channel (PBCH) block (SSB) or non-zero power channel state information-reference signal (NZP CSI-RS)), the pathloss RS is the source RS of QCL Type D or spatial relation associated with the TCI state.

In another example 1.2.1.2, if the source RS of QCL-Type D or spatial relation is an UL RS (e.g., SRS), the pathloss RS is a DL RS (e.g., SSB or periodic NZP CSI-RS) that is a source RS for the UL Type-D or spatial relation source RS associated with the TCI state.

In another example 1.2.1.3, if the source RS of QCL Type D or spatial relation is a DL RS that is a DL aperiodic or semi-persistent RS, the pathloss RS is a DL RS (e.g., SSB or periodic CSI-RS) that is a source RS for the QCL Type-D or spatial relation (DL aperiodic or semi-persistent RS) source RS associated with the TCI state.

In another example 1.2.2, the pathloss RS can be determined by the RS-ID of the QCL info with QCL-Type A or B or C.

In one example 1.2.2.1, if the source RS of QCL-Type A or B or C is a DL periodic RS (e.g., SSB or NZP CSI-RS), the pathloss RS is the source RS of QCL Type A or B or C associated with the TCI state.

In another example 1.2.2.2, if the source RS of QCL-Type A or B or C is an UL RS (e.g., SRS), the pathloss RS is a DL RS (e.g., SSB or periodic NZP CSI-RS) that is a source RS for the UL Type-A or B or C source RS associated with the TCI state.

In another example 1.2.2.3, if the source RS of QCL Type A or B or C is a DL RS that is a DL aperiodic or semi-persistent RS, the pathloss RS is a DL RS (e.g., SSB or periodic CSI-RS) that is a source RS for the QCL Type-A or B or C (DL aperiodic or semi-persistent) source RS associated with the TCI state.

In another example 1.2.3, if the TCI state includes only one QCL Info IE, the pathloss RS can be determined by the RS-ID of the QCL info IE included in the TCI state.

In one example 1.2.3.1, if the source RS of the QCL-Type or spatial relation included in the TCI state is a DL periodic RS (e.g., SSB or NZP CSI-RS), the pathloss RS is the source RS of the QCL-Type or spatial relation included in the TCI state.

In another example 1.2.3.2, if the source RS of the QCL-Type or spatial relation included in the TCI state is an UL RS (e.g., SRS), the pathloss RS is a DL RS (e.g., SSB or periodic NZP CSI-RS) that is a source RS for the UL RS of the QCL-Type or spatial relation included in the TCI state.

In another example 1.2.3.3, if the source RS of the QCL-Type or spatial relation included in the TCI state is a DL aperiodic or semi-persistent RS, the pathloss RS is a DL RS (e.g., SSB or periodic CSI-RS) that is a source RS for the (DL aperiodic or semi-persistent) source RS of the QCL-Type or spatial relation included in the TCI state.

In another example 1.2.4, if the TCI state includes two QCL Info IEs, the QCL Info IE with RS determining the pathloss RS can be configured by RRC signaling and/or MAC CE signaling and/or L1 control signaling.

In one example 1.2.4.1, if the source RS of the QCL-Type or spatial relation configured for pathloss in the TCI state is a DL periodic RS (e.g., SSB or NZP CSI-RS), the pathloss RS is the source RS of the QCL-Type or spatial relation configured for pathloss in the TCI state.

In another example 1.2.4.2, if the source RS of the QCL-Type or spatial relation configured for pathloss in the TCI state is an UL RS (e.g., SRS), the pathloss RS is a DL RS (e.g., SSB or periodic NZP CSI-RS) that is a source RS for the UL RS of the QCL-Type or spatial relation configured for pathloss in the TCI state.

In another example 1.2.4.3, if the source RS of the QCL-Type or spatial relation configured for pathloss in the TCI state is a DL aperiodic or semi-persistent RS, the pathloss RS is a DL RS (e.g., SSB or periodic CSI-RS) that is a source RS for the (DL aperiodic or semi-persistent) source RS of the QCL-Type or spatial relation configured for pathloss in the TCI state.

In one example 1.2a, a TCI state can include or is associated with or linked to a pathloss RS. The presence (inclusion, association or linkage) of the pathloss RS in the TCI state is optional (e.g., as described in example 1.1.1 and 1.1.1A). In such example, if the pathloss RS is included/associated/linked in the TCI state, the UE uses the pathloss RS to measure/estimate the pathloss, or as described in component 4. In such example, if the pathloss RS is not included/not associated/not linked in the TCI state, the UE uses the source RS for determining the UL spatial domain transmit filter, (e.g., source RS of QCL Type-D or spatial relation in the TCI state). In one instance, the UE expects, when the PL RS is not included/not associated/not linked in the TCI state, that the source RS is a periodic DL RS. If the source RS is not a periodic DL RS, it may depend on the UE's implementation to measure/estimate the pathloss. In a variant example, if the PL RS is not included/not associated/not linked in the TCI state, and the source RS is not a periodic RS, the UE doesn't report a pathloss measurement/estimate. In another instance, the UE determines the pathloss RS using the source RS of the UL spatial domain transmit filter (e.g., source RS of QCL Type-D or spatial relation in TCI state) as described in example 1.2.

In another example 1.2b, if the source RS for determining the UL spatial domain transmit filter, (e.g., source RS of QCL Type-D or spatial relation in the TCI state), is a DL periodic RS, the UE uses the source RS as the PL RS for measuring/estimating the pathloss.

In another example 1.2b, if the source RS for determining the UL spatial domain transmit filter, (e.g., source RS of QCL Type-D in the TCI state), is not a DL periodic RS, the UE uses the PL RS included in or associated with or linked to the TCI state for measuring/estimating the pathloss. A UE expects that for an UL TCI state or a Joint TCI state (as applicable), when the source RS for determining the UL spatial domain transmit filter, (e.g., source RS of QCL Type-D or spatial relation in the TCI state) is not a DL periodic RS, that a PL RS is included in, associated with or linked to the TCI state.

In such example, if a PL RS is not included/not associated/not linked in the TCI state, it may depend on the UE's implementation to measure/estimate the pathloss. In such example, in a variant example, if a PL RS is not included/not associated/not linked in the TCI state, the UE doesn't report a pathloss measurement/estimate. In such example, a UE may further expect that the source RS for determining the UL spatial domain transmit filter and the PL RS (when provided) are one of (1) the same, (2) have the same direct or indirect QCL source, (3) one RS is a direct or indirect source RS of the other, or (4) are in the same QCL chain as described in component 4, otherwise the behavior is as described in component 4.

In one example 1.3, the indication of a TCI state to the UE is an indication of the PL RS included in or associated with the TCI state. The UE applies the PL RS in response to the TCI state indication, wherein the indication of the TCI state can be by: (1) a DCI format that includes a beam indication(s), e.g., DL related DCI format (e.g., DCI format 1_0 or DCI format 1_1 or DCI format 1_2 with or without a DL assignment), UL related DCI format (e.g., DCI format 0_0 or DCI format 0_1 or DCI format 0_2 with or without a UL grant), or a purpose designed DCI format for beam indication; and/or (2) a MAC CE that includes a beam indication(s),

In one example 1.3.1, the beam application time of the source RS of the UL and/or DL spatial filter and the application time of the PL RS are the same. Wherein the application time can be measured from one of: (1) the channel (DCI format or MAC CE) containing the TCI state indication; and/or (2) the acknowledgment (e.g., HARQ-ACK) to the channel (DCI format or MAC CE) containing the TCI state indication.

In a further example, the application time can be configured and/or updated by RRC signaling and/or MAC CE signaling and/or L1 control signaling. The application time can further depend on a UE capability. The application time can further depend on the sub-carrier spacing of the channel including the TCI state(s) and/or the channel(s) to which the TCI state(s) is being applied and/or the PL RS (e.g., based on the smallest (or largest) sub-carrier spacing among these channels and/or signals or a subset of them).

In another example 1.3.2, the beam application time of the source RS of the UL and/or DL spatial filter and the application time of the PL RS are different. Wherein the application times can be measured from one of: (1) the channel (DCI format or MAC CE) containing the TCI state indication; and/or (2) the acknowledgment (HARQ-ACK) to the channel (DCI format or MAC CE) containing the TCI state indication.

In a further example, the application times can be configured and/or updated by RRC signaling and/or MAC CE signaling and/or L1 control signaling. The application times can further depend on a UE capability. The application times can further depend on the sub-carrier spacing of the channel including the TCI state(s) and/or the channel(s) to which the TCI state(s) is being applied and/or the PL RS (e.g., based on the smallest (or largest) sub-carrier spacing among these channels and/or signals or a subset of them).

In one example 1.4, the indication of a TCI state to the UE that is applied to multiple component carriers is an indication of the PL RS included in or associated with the TCI state. The UE applies the PL RS in response to the TCI state indication, wherein the indication of the TCI state can be by: (1) a DCI Format that includes a beam indication(s), e.g., DL related DCI format (e.g., DCI Format 1_0 or DCI Format 1_1 or DCI Format 1_2 with or without a DL assignment), UL related DCI format (e.g., DCI Format 0_0 or DCI Format 0_1 or DCI Format 0_2 with or without a UL grant), or a purpose designed DCI Format for beam indication; and/or (2) a MAC CE that includes a beam indication(s).

In one example 1.4.1, a common source RS of the UL and/or DL spatial filter is determined for all component carriers.

In another example 1.4.2, a source RS of the UL and/or DL spatial filter is determined for each component carrier.

In another example 1.4.3, the component carriers are partitioned into sub-sets and a source RS of the UL and/or DL spatial filter is determined for each subset.

In one example 1.4.4, a common path loss RS (PLRS) is determined for all component carriers.

In another example 1.4.5, a PLRS is determined for each component carrier.

In another example 1.4.6, the component carriers are partitioned into sub-sets and a PLRS is determined for each subset.

In one example 1.4.7, the beam application time of the source RS of the UL and/or DL spatial filter and the application time of the PL RS are the same.

In one example 1.4.7.1, the beam application time of the source RS of the UL and/or DL spatial filter and the application time of the PL RS are the same across all component carriers.

In one example 1.4.7.2, the beam application time of the source RS of the UL and/or DL spatial filter and the application time of the PL RS are the same for each component carrier, but can be different for different component carriers.

In one example 1.4.7.3, the beam application time of the source RS of the UL and/or DL spatial filter and the application time of the PL RS are the same across a subset of component carriers but can be different for different subsets of component carriers.

Wherein the application time can be measured from one of: (1) the channel (DCI Format or MAC CE) containing the TCI state indication; or (2) the acknowledgment (e.g., HARQ-ACK) to the channel (DCI Format or MAC CE) containing the TCI state indication.

In a further example, the application time can be configured and/or updated by RRC signaling and/or MAC CE signaling and/or L1 control signaling. The application time can further depend on a UE capability. The application time can further depend on the sub-carrier spacing of the channel including the TCI state(s) and/or the channel(s) to which the TCI state(s) is being applied and/or the PL RS (e.g., based on the smallest (or largest) sub-carrier spacing among these channels and/or signals or a subset of them).

In a further example, when the application time is the same across all component carriers or across a subset of component carriers, the application time is the maximum time across all component carriers or across a subset of component carriers respectively. For example, the application time can be determined (or configured) for each component carrier (e.g., based on sub-carrier spacing of the component carrier and other characteristics of the component carrier), the maximum application time is then determined across all component carriers or across a subset of component carriers, respectively, and is used as a common time for beam application and PLRS application across all the component carriers or across a subset of the component carriers respectively.

In another example 1.4.8, the beam application time of the source RS of the UL and/or DL spatial filter and the application time of the PL RS are different.

In one example 1.4.8.1, the beam application time of the source RS of the UL and/or DL spatial filter is the same across all component carriers.

In one example 1.4.8.2, the beam application time of the source RS of the UL and/or DL spatial filter can be different for each component carrier.

In one example 1.4.8.3, the beam application time of the source RS of the UL and/or DL spatial filter is the same across a subset of component carriers but can be different for different subsets of component carriers.

In one example 1.4.8.4, the application time of the PL RS is the same across all component carriers.

In one example 1.4.8.5, the application time of the PL RS can be different for each component carrier.

In one example 1.4.8.6, the application time of the PL RS is the same across a subset of component carriers but can be different for different subsets of component carriers.

Wherein the application times can be measured from one of: (1) the channel (DCI Format or MAC CE) containing the TCI state indication; or (2) the acknowledgment (e.g., HARQ-ACK) to the channel (DCI Format or MAC CE) containing the TCI state indication.

In a further example, the application times can be configured and/or updated by RRC signaling and/or MAC CE signaling and/or L1 control signaling. The application times can further depend on a UE capability. The application times can further depend on the sub-carrier spacing of the channel including the TCI state(s) and/or the channel(s) to which the TCI state(s) is being applied and/or the PL RS (e.g., based on the smallest (or largest) sub-carrier spacing among these channels and/or signals or a subset of them).

In a further example, when the application time is the same across all component carriers or across a subset of component carriers, the application time is the maximum time across all component carriers or across a subset of component carriers respectively. For example, the application time can be determined (or configured) for each component carrier (e.g., based on sub-carrier spacing of the component carrier and other characteristics of the component carrier), the maximum application time is then determined across all component carriers or across a subset of component carriers, respectively, and is used as a common time for beam application or PLRS application across all the component carriers or across a subset of the component carriers respectively.

In the examples of component 1, the pathloss RS can be indicated by, included in, associated with or linked to a Joint TCI state or an UL TCI state.

For component 2, UL parameters can include additional UL timing parameters such as a TCI state specific timing offset (to account for different propagation delays of different beams) and UL power control parameters such as P0, alpha and CL index. In general, the UL parameters can depend on an UL channel or UL signal to which the UL transmission parameters are being applied (e.g., PUSCH or PUCCH or SRS), as well a beam direction (e.g., a TCI state). Having each UL transmission parameter determined based on an UL channel or UL signal and a TCI state, leads to many number of configured values for each UL parameter which is the product of the number of channels/signals by the number of TCI states, leading to a large configuration overhead.

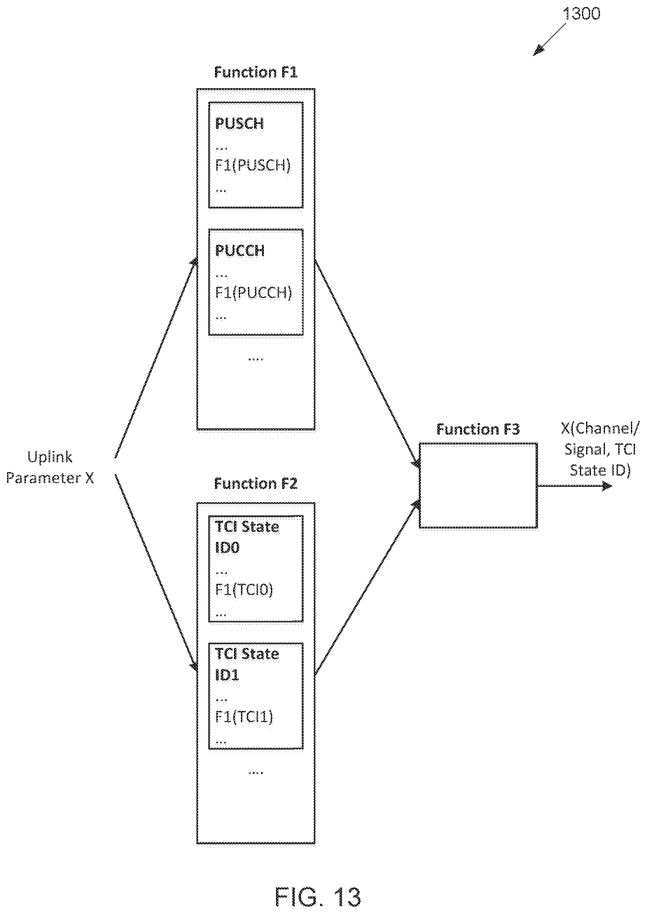

Instead, the present disclosure provides that any UL transmission parameter X, where X can be, for example, a TCI-state specific timing offset, P0, alpha, CL index, is determined by a combination (a third function) of two functions, a first function that depends on the UL channel or UL signal and a second function that depends on the TCI state, as illustrated in FIG. 13.

FIG. 13 illustrates an example of determination of UL parameters in TCI state 1300 according to embodiments of the present disclosure. An embodiment of the UL parameters in TCI state 1300 shown in FIG. 13 is for illustration only.

In one example, the third function can be the sum of the operands, i.e., .

In another example, the third function can be the product of the operands, i.e., .

In another example, the third function can be any function of the operands.

In one example, the first function is provided by a look up table, i.e., for each channel or signal, the corresponding output of the first function is specified in the system specifications and/or configured or updated by RRC signaling and/or MAC CE signaling and/or L1 control signaling.

In one example, the second function is provided by a look up table, i.e., for each TCI state ID, the corresponding output of the second function is specified in the system specifications and/or configured or updated by RRC signaling and/or MAC CE signaling and/or L1 control signaling. A UE can determine, the component of parameter that depends on the TCI State ID, i.e., after the UE has been signaled a TCI State ID. For example, the parameter is included in or linked to or associated with the TCI state.

In another example, the parameter only depends on the channel and/or signal, i.e., the parameter doesn't depend on the TCI State ID.

In another example, the parameter only depends on the TCI State ID, i.e., the parameter doesn't depend on the channel or signal.

In one example, the additional UL timing offset parameter is independent of the UL channel or UL signal, but depends on the TCI state ID. Therefore, additional UL Timing Offset=F2_TimingOffset (TCI State ID), wherein, the TCI state can include the parameter F2_TimingOffset (TCI State ID).

In one example, the power control parameter P0 can depend on the UL channel or UL signal and on the TCI State ID. Therefore, P0=F1_P0 (Channel/Signal)+F2_P0 (TCI State ID), wherein, F1_P0 (Channel/Signal) is specified in the system specifications and/or configured or updated by RRC signaling and/or MAC CE signaling and/or L1 control signaling for each UL channel or UL signal. The TCI State ID can include the parameter F2_P0 (TCI State ID).

In another example, the power control parameter P0 is independent of the UL channel or UL signal, but depends on the TCI state ID. Therefore, P0=F2_P0 (TCI State ID), wherein, the TCI State can include the parameter F2_P0 (TCI State ID).

In another example, the power control parameter P0 is independent of the TCI State ID, but depends on the UL channel or UL signal. Therefore, P0=F1_P0 (Channel/Signal), wherein, F1_P0 (Channel/Signal) is specified in the system specifications and/or configured or updated by RRC signaling and/or MAC CE signaling and/or L1 control signaling for each UL channel or UL signal.

In one example, the power control parameter alpha (fractional pathloss compensation factor) can depend on the UL channel or UL signal and on the TCI State ID. Therefore, alpha=F1_alpha (Channel/Signal)*F2_alpha (TCI State ID), wherein, F1_alpha (Channel/Signal) is specified in the system specifications and/or configured or updated by RRC signaling and/or MAC CE signaling and/or L1 control signaling for each UL channel or UL signal. The TCI State ID can include the parameter F2_alpha (TCI State ID).

In another example, the power control parameter alpha is independent of the UL channel or UL signal, but depends on the TCI state ID. Therefore, alpha=F2_alpha (TCI State ID), wherein, the TCI State can include the parameter F2_alpha (TCI State ID).

In another example, the power control parameter alpha is independent of the TCI State ID, but depends on the UL channel or UL signal. Therefore, alpha =F1_alpha (Channel/Signal), wherein, F1_alpha (Channel/Signal) is specified in the system specifications and/or configured or updated by RRC signaling and/or MAC CE signaling and/or L1 control signaling for each UL channel or UL signal.

In one example, the power control closed loop index is the power control adjustment state index.

In one example, the power control closed loop (CL) index can depend on the UL channel or UL signal and on the TCI State ID. Therefore, CLID=F1_CLID (Channel/Signal)+F2_CLID (TCI State ID), wherein, F1_CLID (Channel/Signal) is specified in the system specifications and/or configured or updated by RRC signaling and/or MAC CE signaling and/or L1 control signaling for each UL channel or UL signal. The TCI State ID can include the parameter F2_CLID (TCI State ID).

In another example, the power control CL index is independent of the UL channel or UL signal, but depends on the TCI state ID. Therefore, CLID=F2_CLID (TCI State ID), wherein, the TCI State can include the parameter F2_CLID (TCI State ID).

In another example, the power control parameter alpha is independent of the TCI State ID, but depends on the UL channel or UL signal. Therefore, alpha=F1_CLID (Channel/Signal), wherein, F1_CLID (Channel/Signal) is specified in the system specifications and/or configured or updated by RRC signaling and/or MAC CE signaling and/or L1 control signaling for each UL channel or UL signal.

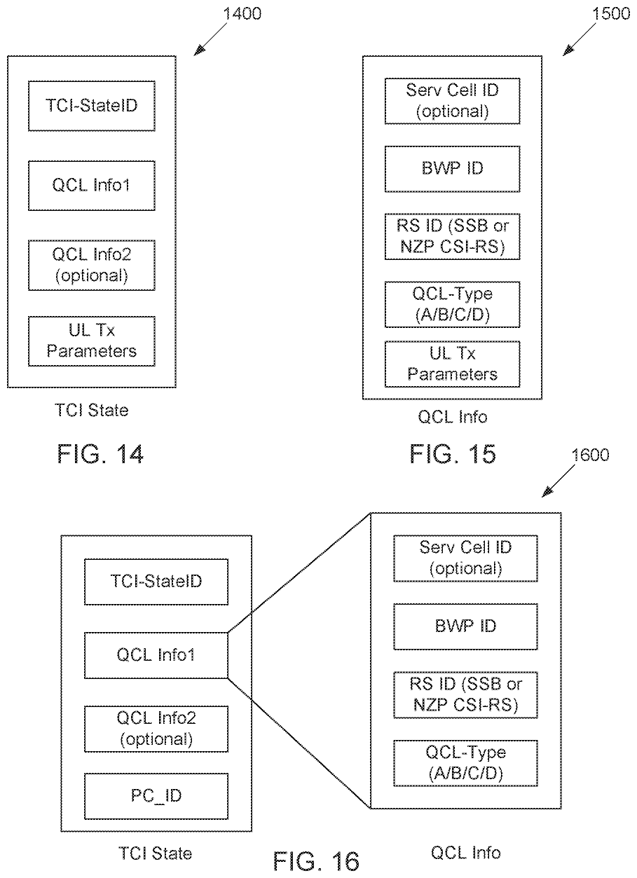

FIG. 14 illustrates an example of TCI state 1400 according to embodiments of the present disclosure. An embodiment of the TCI state 1400 shown in FIG. 14 is for illustration only.

In one example 2.1, a TCI state can include an IE for the UL transmission parameters as shown in FIG. 14. The presence of an IE for UL transmission parameters can be optional (e.g., it can be absent) and may not be included, or the UL transmission parameter IE is always present and can be set to a default dummy value (when not used). Optionally, the presence or absence of the UL transmission IE can be configured. The UL transmission IE can include one or more UL transmission parameters, each UL transmission parameter within the UL transmission parameters IE can be optional (e.g., it can be absent) and may not be included, an UL transmission parameter within the UL transmission parameters IE is always present and can be set to a default dummy value (when not used). Optionally, the presence or absence of an UL transmission parameter within the UE transmission parameters IE can be configured.

If an UL transmission parameter is absent from a TCI state, a default value specified in the system specification and/or configured or updated by higher layer signaling (RRC and/or MAC CE) is used instead for that UL transmission parameter.

In another example 2.1.1, UL transmission parameters are individually included in the TCI state. The presence of an UL transmission parameter can be optional (e.g., it can be absent) and may not be included, or the UL transmission parameter is always present and can be set to a default dummy value (when not used). Optionally, the presence or absence of an UL transmission can be configured.

FIG. 15 illustrates an example of QCL information 1500 according to embodiments of the present disclosure. An embodiment of the QCL information 1500 shown in FIG. 15 is for illustration only.

In another example 2.2, a QCL Info can include an IE for the UL transmission parameters as shown in FIG. 15. The presence of an IE for UL transmission parameters can be optional (e.g., it can be absent) and may not be included, or the UL transmission parameters IE is always present and can be set to a default dummy value (when not used). Optionally, the presence or absence of the UL transmission parameters IE can be configured. The UL transmission parameters IE can include one or more UL transmission parameters, each UL transmission parameter within an UL transmission parameters IE can be optional (e.g., it can be absent) and may not be included, or an UL transmission parameter within the UL transmission parameters IE is always present and can be set to a default dummy value (when not used). Optionally, the presence or absence of an UL transmission parameter within the UL transmission parameters IE can be configured.

If an UL transmission parameter is absent from a TCI state (QCL Info), a default value specified in the system specification and/or configured or updated by higher layer signaling (RRC and/or MAC CE) is used instead for that UL parameter.

In another example 2.2.1, UL transmission parameters are individually included in the QCL Info. The presence of an UL transmission parameter can be optional (e.g., it can be absent) and may not be included, or the UL transmission parameter is always present and can be set to a default dummy value (when not used). Optionally, the presence or absence of an UL transmission parameter can be configured.

In one example 2.2.2, if a TCI state includes two QCL info IEs, and the QCL info IE includes UL transmission parameters, the QCL Info IE including the UL transmission parameters (or UL transmission parameters IE) can be configured by RRC signaling and/or MAC CE signaling and/or L1 control signaling, and the UL transmission parameters can be indicated by the UL transmission parameters (or UL transmission parameter IE) of the configured QCL info IE.

In another example 2.2.2.1, if the TCI state includes two QCL Info IEs, the UL transmission parameters can be indicated by the UL transmission parameters (or the UL transmission parameters IE) of the first QCL info IE (QCL-info1) included in the TCI state.

In another example 2.2.2.2, if the TCI state includes two QCL Info IEs, the UL transmission parameters can be indicated by the UL transmission parameters (or UL transmission parameters IE) of the second QCL info IE (QCL-info2) included in the TCI state.

In another example 2.2.3, if a TCI state includes only one QCL Info IE (QCL-info1), i.e., the second QCL Info (QCL-info2) is absent, but the IE for the QCL-info2 can be used for the UL transmission parameters or UL transmission parameters IE.

In one example 2.3.1, the pathloss RS and the UL transmission parameters (or UL transmission parameters IE) are both included in TCI state (FIG. 9 and FIG. 14).

In one example 2.3.1.1, the pathloss RS and the UL transmission parameters (or UL transmission parameters IE) are both included in TCI state and have a joint IE.

In another example 2.3.1.2, the pathloss RS and the UL transmission parameters (or UL transmission parameters IE) are both included in TCI state but have separate IEs.

In another example 2.3.2, the pathloss RS and the UL transmission parameters (or UL transmission parameters IE) are both included in QCL Info (FIG. 10 and FIG. 15).

In one example 2.3.2.1, the pathloss RS and the UL transmission parameters (or UL transmission parameters IE) are both included in a same QCL Info and have a joint IE.

In another example 2.3.2.2, the pathloss RS and the UL transmission parameters (or UL transmission parameters IE) are both included in a same QCL Info but have separate IEs.

In another example 2.3.2.3, the pathloss RS and the UL transmission parameters (or UL transmission parameters IE) are both included in separate QCL Information.

In another example 2.4.1, either the pathloss RS or the UL transmission parameters (or UL transmission parameters IE) is included in a TCI state. The pathloss RS or the UL transmission parameters (or UL transmission parameters IE) can be configured by RRC signaling and/or by MAC CE signaling and/or by L1 control signaling whether the pathloss RS or the UL transmission parameters (or UL transmission parameters IE) is included in the TCI state.

In another example 2.4.2, either the pathloss RS or the UL transmission parameters (or UL transmission parameters IE) is included in a QCL Info. The pathloss RS or the UL transmission parameters (or UL transmission parameters IE) can be configured by RRC signaling and/or by MAC CE signaling and/or by L1 control signaling whether the pathloss RS or the UL transmission parameters (or UL transmission parameters IE) is included in the QCL Info.

In another example 2.5.1, either the pathloss RS or the UL transmission parameters (or UL transmission parameters IE) or both are included in a TCI state. The pathloss RS or the UL transmission parameters (or UL transmission parameters IE) or both can be configured by RRC signaling and/or by MAC CE signaling and/or by L1 control signaling whether the pathloss RS or the UL transmission parameters (or UL transmission parameters IE) or both are included in the TCI state.

In one example 2.5.1.1, if both the pathloss RS and the UL transmission parameters (or UL transmission parameters IE) are included in the TCI state, the pathloss RS and the UL transmission parameters (or UL transmission parameters IE) have a joint IE.

In another example 2.5.1.2, if both the pathloss RS and the UL transmission parameters (or UL transmission parameters IE) are both included in the TCI state, the pathloss RS and the UL transmission parameters (or UL transmission parameters IE) have separate IEs.

In another example 2.5.2, either the pathloss RS or the UL transmission parameters (or UL transmission parameters IE) or both are included in a QCL Info. The pathloss RS or the UL transmission parameters (or UL transmission parameters IE) or both can be configured by RRC signaling and/or by MAC CE signaling and/or by L1 control signaling whether the pathloss RS or the UL transmission parameters (or UL transmission parameters IE) or both are included in the QCL Info.

In one example 2.5.2.1, if both the pathloss RS and the UL transmission parameters (or UL transmission parameters IE) are included in a same QCL Info, the pathloss RS and the UL transmission parameters (or UL transmission parameters IE)have a joint IE.

In another example 2.5.2.2, if both the pathloss RS and the UL transmission parameters (or UL transmission parameters IE) are both included in a same QCL Info, the pathloss RS and the UL transmission parameters (or UL transmission parameters IE) have separate IEs.

In another example 2.5.2.3, pathloss RS is included in a first QCL Info, UL transmission parameters (or UL transmission parameters IE) is included in a second QCL Info.

In the examples of component 2, the UL transmission parameters can be indicated by, included in, associated with or linked to a Joint TCI state or an UL TCI state. In the examples of component 2, the UL transmission parameters can include only power control parameters (or a subset of the power control parameters, P0, alpha and power control closed loop index) or can only include UL time advance (time alignment offset) or can include both power control parameters and UL time advance.

For component 3, in one example 3.1, a network configures a list (array) of the UL transmission parameters, e.g., power control parameters and/or PL-RS and/or time alignment offset (TA offset). A TCI state is linked or associated to an element of the List or array for power control parameters and/or PL-RS and/or time alignment offset (TA offset).

In one example 3.1.1, the network configures a list or array of power control parameters, e.g., P0 and/or alpha and/or CL index as illustrated in TABLE 1.

TABLE 1

| | PC Control Parameters (P0 and/or alpha |
|---|---|
| PC_ID | (α) and/or CL Index (CLID)) |
| 0 | P0₀ and/or α₀ and/or CLID₀ |
| 1 | P0₁ and/or α₁ and/or CLID₁ |
| . . . | . . . |
| n − 1 | P0ₙ₋₁ and/or αₙ₋₁ and/or CLIDₙ₋₁ |

In another example 3.1.2, the network configures a list or array of path loss reference signals as illustrated in TABLE 2. A path loss RS, can include, for example, path loss RS type (e.g., SSB or NZP CSI-RS) and the corresponding RS ID.

TABLE 2

| PLRS_ID | PL Reference Signal |
|---|---|
| 0 | PL₀ |
| 1 | PL₁ |
| . . . | . . . |
| n − 1 | PLₙ₋₁ |

In another example 3.1.3, the network configures a list or array of power control parameters (e.g., P0 and/or alpha and/or CL index) and path loss reference signals as illustrated in TABLE 3.

TABLE 3

| | PC Control Parameters (P0 and/or alpha |
|---|---|
| PC_PLRS_ID | (α) and/or CL Index (CLID)) and PL RS |
| 0 | (P0₀ and/or α₀ and/or CLID₀) and PL₀ |
| 1 | (P0₁ and/or α₁ and/or CLID₁) and PL₁ |
| . . . | . . . |
| n − 1 | (P0ₙ₋₁ and/or αₙ₋₁ and/or CLIDₙ₋₁) and PLₙ₋₁ |

In another example 3.1.4, the network configures a list or array of UL parameters, e.g., P0 and/or alpha and/or CL index and/or TA offset as illustrated in TABLE 4.

TABLE 4

| | PC Control Parameters (P0 and/or alpha |
|---|---|
| ULParam_ID | (α) and/or CL Index (CLID) and/or TA) |
| 0 | P0₀ and/or α₀ and/or CLID₀ and/or TA₀ |
| 1 | P0₁ and/or α₁ and/or CLID₁ and/or TA₁ |
| . . . | . . . |
| n − 1 | P0ₙ₋₁ and/or αₙ₋₁ and/or CLIDₙ₋₁ and/or TAₙ₋₁ |

In another example 3.1.5, the network configures a list or array of UL parameters (e.g., P0 and/or alpha and/or CL index and/or TA offset) and path loss reference signals as illustrated in TABLE 5.

TABLE 5

| ULParam_PL | PC Control Parameters (P0 and/or alpha |
|---|---|
| RS_ID | (α) and/or CL Index (CLID)) and PL RS |
| 0 | (P0₀ and/or α₀ and/or CLID₀ and/or TA₀) and PL₀ |
| 1 | (P0₁ and/or α₁ and/or CLID₁ and/or TA₁) and PL₁ |
| . . . | . . . |
| n − 1 | (P0ₙ₋₁ and/or αₙ₋₁ and/or CLIDₙ₋₁ and/or TAₙ₋₁) |
| | and PLₙ₋₁ |

In one example 3.1.6, TABLE 1 to TABLE 5, as applicable, can be common to all uplink channels and signals (e.g., PUSCH, PUCCH and SRS). In a further example, an additional channel specific component can be applied as described in component 2 (e.g., FIG. 13).

In another example 3.1.7, TABLE 1 to TABLE 5, as applicable, can be configured to one or more uplink channels and signals (e.g., PUSCH, PUCCH or SRS). For example: (1) one table configured for PUSCH and/or one table configured for PUCCH and/or one table configured for SRS; (2) one table configured for PUSCH and PUCCH and/or one table configured for SRS; (3) one table configured for PUSCH and SRS and/or one table configured for PUCCH; and/or (4) one table configured for PUCCH and SRS and/or one table configured for PUSCH.

In one example 3.1.8, TABLE 1 to TABLE 5 are configured by RRC signaling and can be further updated by RRC signaling and/or MAC CE signaling.

In one example 3.2, the network configures a PC_ID and/or a PLRS_ID and/or PC_PLRS_ID and/or ULParam_ID and/or ULParam_PLRS_ID, wherein PC_ID, a PLRS_ID, PC_PLRS_ID, ULParam_ID and ULParam_PLRS_ID are as described in TABLE 1 to TABLE 5 in the TCI state or QCL info.

In one example 3.2.1, the PC_ID is included in the TCI state as indicated in FIG. 16.

FIG. 16 illustrates an example of TCI state and QCL information 1600 according to embodiments of the present disclosure. An embodiment of the TCI state and QCL information 1600 shown in FIG. 16 is for illustration only.

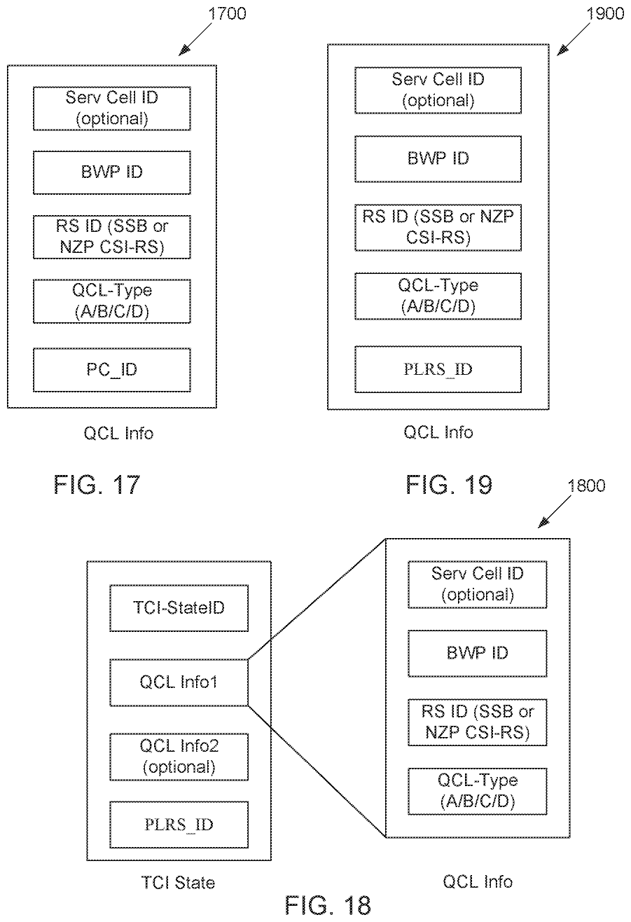

In another example 3.2.2, the PC_ID is included in the QCL info as indicated in FIG. 17. In further example, the PC_ID is included in QCL info of QCL TypeD.

FIG. 17 illustrates an example of QCL information 1700 according to embodiments of the present disclosure. An embodiment of the QCL information 1700 shown in FIG. 17 is for illustration only.

In another example 3.2.3, the PLRS_ID is included in the TCI state as indicated in FIG. 18.

FIG. 18 illustrates an example of TCI state and QCL information 1800 according to embodiments of the present disclosure. An embodiment of the TCI state and QCL information 1800 shown in FIG. 18 is for illustration only.

In another example 3.2.4, the PLRS_ID is included in the QCL info as indicated in FIG. 19. In further example, the PLRS_ID is included in QCL info of QCL TypeD.

FIG. 19 illustrates an example of QCL information 1900 according to embodiments of the present disclosure. An embodiment of the QCL information 1900 shown in FIG. 19 is for illustration only.

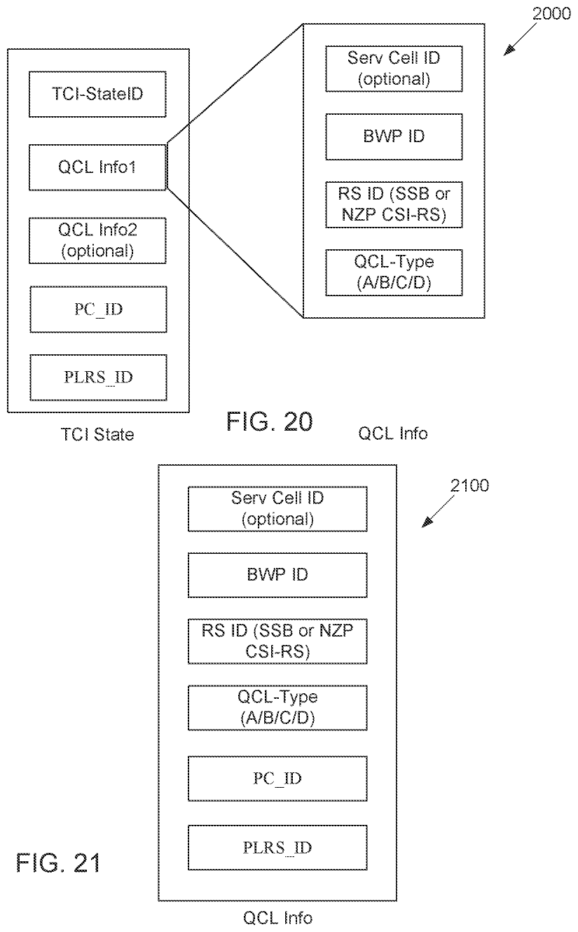

In another example 3.2.5, the PC_ID and PLRS_ID are included in the TCI state as indicated in FIG. 20.

FIG. 20 illustrates an example of TCI state and QCL information 2000 according to embodiments of the present disclosure. An embodiment of the TCI state and QCL information 2000 shown in FIG. 20 is for illustration only.

In another example 3.2.6, the PC_ID and PLRS_ID is included in the QCL info as indicated in FIG. 21. In further example, the PC_ID and PLRS_ID are included in QCL info of QCL TypeD.

FIG. 21 illustrates an example of QCL information 2100 according to embodiments of the present disclosure. An embodiment of the QCL information 2100 shown in FIG. 21 is for illustration only.

In another example 3.2.6a, the PC_ID is included in the TCI state, and the PLRS_ID is included in the QCL info. In further example, the PLRS_ID is included in QCL info of QCL TypeD.

In another example 3.2.6b, the PLRS_ID is included in the TCI state, and the PC_ID is included in the QCL info. In further example, the PC_ID is included in QCL info of QCL TypeD.

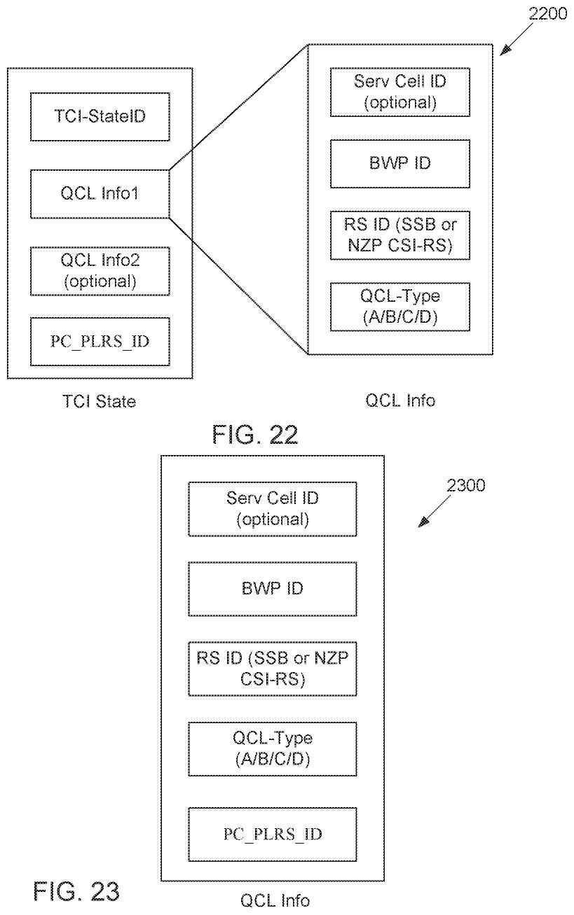

In another example 3.2.7, the PC_PLRS_ID is included in the TCI state as indicated in FIG. 22.

FIG. 22 illustrates an example of TCI state and QCL information 2200 according to embodiments of the present disclosure. An embodiment of the TCI state and QCL information 2200 shown in FIG. 22 is for illustration only.

In another example 3.2.8, the PC_PLRS_ID is included in the QCL info as indicated in FIG. 23. In further example, the PC_PLRS_ID is included in QCL info of QCL TypeD.

FIG. 23 illustrates an example of QCL information 2300 according to embodiments of the present disclosure. An embodiment of the QCL information 2300 shown in FIG. 23 is for illustration only.

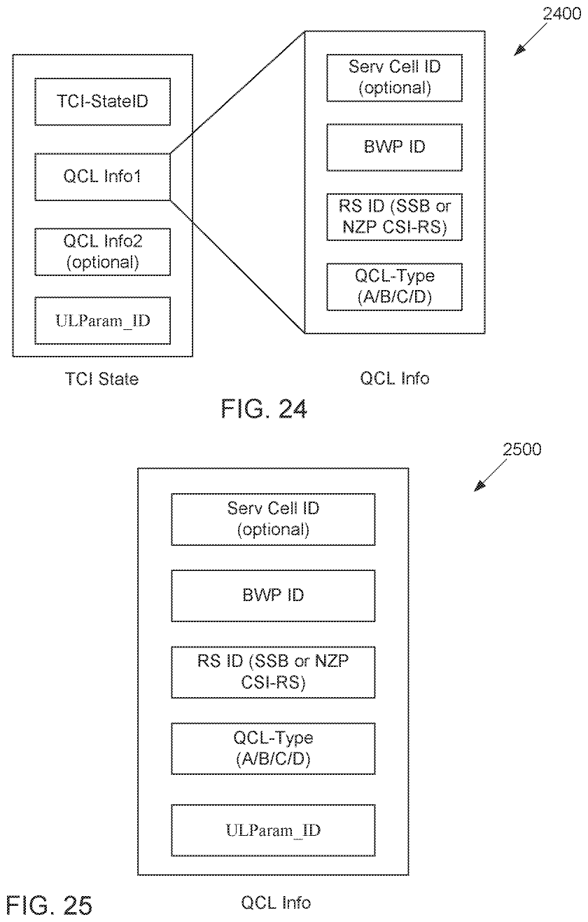

In another example 3.2.9, the ULParam_ID is included in the TCI state as indicated in FIG. 24.

FIG. 24 illustrates an example of TCI state and QCL information 2400 according to embodiments of the present disclosure. An embodiment of the TCI state and QCL information 2400 shown in FIG. 24 is for illustration only.

In another example 3.2.10, the ULParam_ID is included in the QCL info as indicated in FIG. 25. In further example, the ULParam_ID is included in QCL info of QCL TypeD.

FIG. 25 illustrates an example of QCL information 2500 according to embodiments of the present disclosure. An embodiment of the QCL information 2500 shown in FIG. 25 is for illustration only.

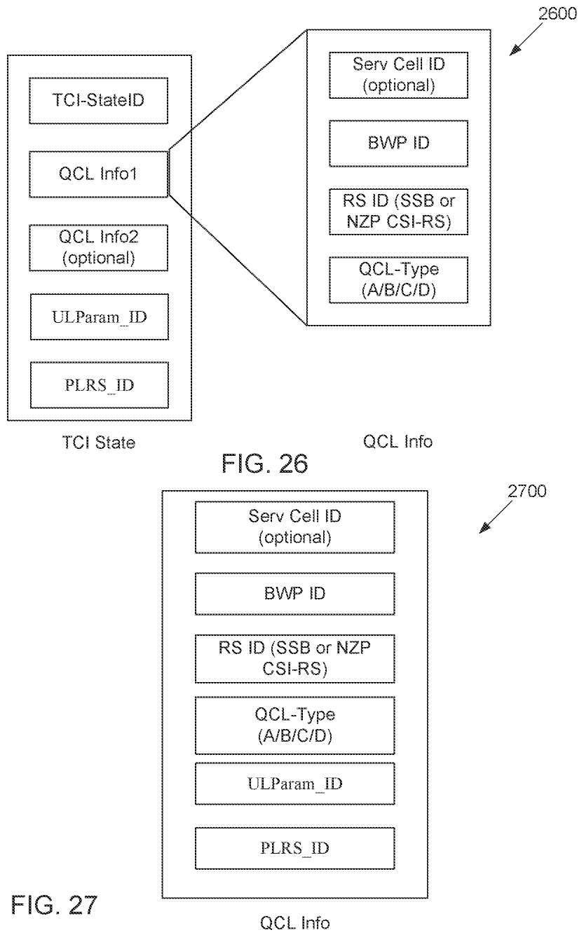

In another example 3.2.11, the ULParam_ID and PLRS_ID are included in the TCI state as indicated in FIG. 26.

FIG. 26 illustrates an example of TCI state and QCL information 2600 according to embodiments of the present disclosure. An embodiment of the TCI state and QCL information 2600 shown in FIG. 26 is for illustration only.

In another example 3.2.12, the ULParam_ID and PLRS_ID is included in the QCL info as indicated in FIG. 27. In further example, the ULParam_ID and PLRS_ID are included in QCL info of QCL TypeD.

FIG. 27 illustrates an example of QCL information 2700 according to embodiments of the present disclosure. An embodiment of the QCL information 2700 shown in FIG. 27 is for illustration only.

In another example 3.2.12a, the ULParam_ID is included in the TCI state, and the PLRS_ID is included in the QCL info. In further example, the PLRS_ID is included in QCL info of QCL TypeD.

In another example 3.2.12b, the PLRS_ID is included in the TCI state, and the ULParam_ID is included in the QCL info. In further example, the ULParam_ID is included in QCL info of QCL TypeD.

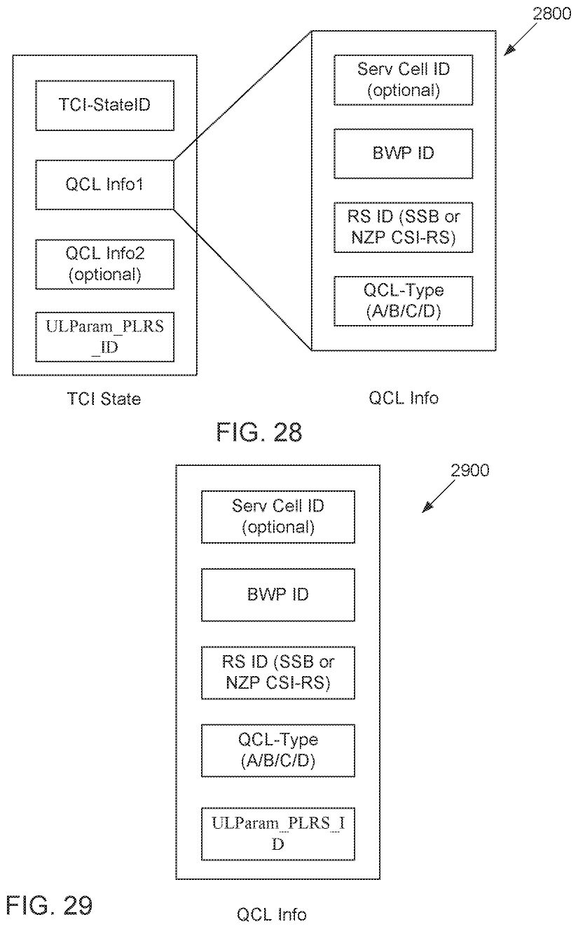

In another example 3.2.13, the ULParam_PLRS_ID is included in the TCI state as indicated in FIG. 28.

FIG. 28 illustrates an example of TCI state and QCL information 2800 according to embodiments of the present disclosure. An embodiment of the TCI state and QCL information 2800 shown in FIG. 28 is for illustration only.

In another example 3.2.14, the ULParam_PLRS_ID is included in the QCL info as indicated in FIG. 29. In further example, the ULParam_PLRS_ID is included in QCL info of QCL TypeD.

FIG. 29 illustrates an example of QCL information 2900 according to embodiments of the present disclosure. An embodiment of the QCL information 2900 shown in FIG. 29 is for illustration only.

In one example 3.2.15, TABLE 1 to TABLE 5, as applicable, can be common to all uplink channels and signals (e.g., PUSCH, PUCCH and SRS) and hence a common ID(s) is included in the TCI state or QCL Info. In a further example, an additional channel specific component can be applied as described in component 2 (e.g., FIG. 13).

In another example 3.2.16, TABLE 1 to TABLE 5, as applicable, can be configured to one or more uplink channels and signals (e.g., PUSCH, PUCCH or SRS). For example: (1) one table configured for PUSCH and/or one table configured for PUCCH and/or one table configured for SRS; (2) one table configured for PUSCH and PUCCH and/or one table configured for SRS; (3) one table configured for PUSCH and SRS and/or one table configured for PUCCH; and/or (4) one table configured for PUCCH and SRS and/or one table configured for PUSCH.

In one example 3.2.16.1, separate IDs are included in the TCI state or QCL info, one associated with each configured table.

In another example 3.2.16.2, a common ID(s) is included in the TCI state or QCL info. The common ID(s) points to an entry with the same ID in each of the configured tables.

In one example 3.3, the network configures a PC_ID and/or a PLRS_ID and/or PC_PLRS_ID and/or ULParam_ID and/or ULParam_PLRS_ID, wherein PC_ID, a PLRS_ID, PC_PLRS_ID, ULParam_ID and ULParam_PLRS_ID are as described in TABLE 1 to TABLE 5, by MAC CE signaling associated with the activated TCI states.

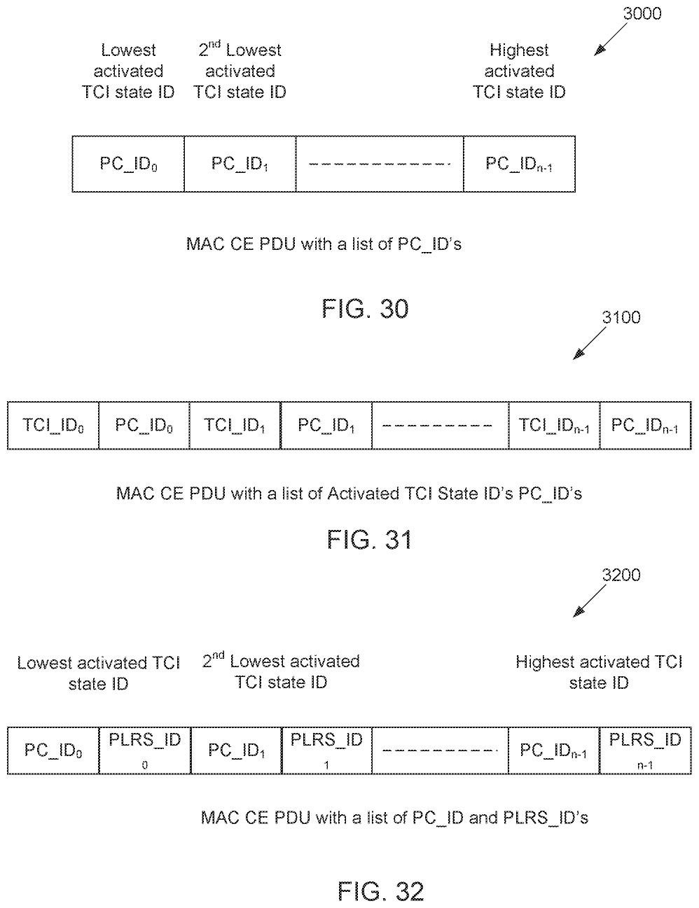

In one example 3.3.1, a list of PC_IDs is included in the MAC CE, wherein a first PC_ID is associated with a first TCI state ID (e.g., lowest activated TCI State ID), a next second PC_ID is associated with a second TCI state ID (e.g., a second lowest activated TCI State ID). This is illustrated in FIG. 30.

FIG. 30 illustrates an example of MAC CE PDU 3000 according to embodiments of the present disclosure. An embodiment of the MAC CE PDU 3000 shown in FIG. 30 is for illustration only.

In a variant example 3.3.1.1, the list of PC_IDs is included in a DCI Format.

In one example 3.3.2, a list of PC_IDs and activated TCI state IDs is included in the MAC CE. This is illustrated in FIG. 31.

FIG. 31 illustrates another example of MAC CE PDU 3100 according to embodiments of the present disclosure. An embodiment of the MAC CE PDU 3100 shown in FIG. 31 is for illustration only.

In a variant example 3.3.2.1, the list of PC_IDs and TCI state IDs is included in a DCI format.

In one example 3.3.3, a list of PLRS_IDs is included in the MAC CE, wherein a first PLRS_ID is associated with a first TCI state ID (e.g., lowest activated TCI State ID), a next second PLRS_ID is associated with a second TCI state ID (e.g., a second lowest activated TCI State ID). This is similar to FIG. 30 with PC_ID replaced by PLRS_ID.

In a variant example 3.3.3.1, the list of PLRS_IDs is included in a DCI Format.

In one example 3.3.4, a list of PLRS_IDs and activated TCI state IDs is included in the MAC CE. This is similar to FIG. 31 with PC_ID replaced by PLRS_ID.

In a variant example 3.3.4.1, the list of PLRS_IDs and TCI state IDs is included in a DCI Format.

In one example 3.3.5, a list of PC_IDs and PLRS_IDs is included in the MAC CE, wherein a first PC_ID and PLRS_ID is associated with a first TCI state ID (e.g., lowest activated TCI State ID), a next second PC_ID and PLRS_ID is associated with a second TCI state ID (e.g., a second lowest activated TCI State ID). This is illustrated in FIG. 32.

FIG. 32 illustrates yet another example of MAC CE PDU 3200 according to embodiments of the present disclosure. An embodiment of the MAC CE PDU 3200 shown in FIG. 32 is for illustration only.

In a variant example 3.3.5.1, the list of PC_IDs and PLRS_IDs is included in a DCI format.

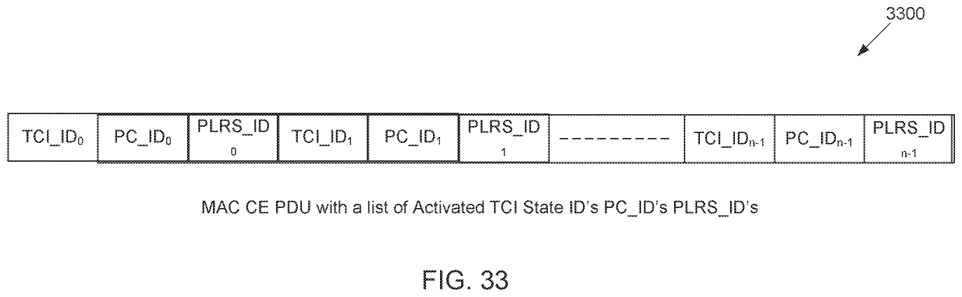

In one example 3.3.6, a list of PC_IDs and PLRS_IDs and activated TCI state IDs is included in the MAC CE. This is illustrated in FIG. 33.

FIG. 33 illustrates yet another example of MAC CE PDU 3300 according to embodiments of the present disclosure. An embodiment of the MAC CE PDU 3300 shown in FIG. 33 is for illustration only.

In a variant example 3.3.6.1, the list of PC_IDs and PLRS_IDs and TCI state IDs is included in a DCI format.

In one example 3.3.7, a list of PC_PLRS_IDs is included in the MAC CE, wherein a first PC_PLRS_ID is associated with a first TCI state ID (e.g., lowest activated TCI State ID), a next second PC_PLRS_ID is associated with a second TCI state ID (e.g., a second lowest activated TCI State ID). This is similar to FIG. 30 with PC_ID replaced by PC_PLRS_ID.

In a variant example 3.3.7.1, the list of PC_PLRS_IDs is included in a DCI Format.

In one example 3.3.8, a list of PC_PLRS_IDs and activated TCI state IDs is included in the MAC CE. This is similar to FIG. 31 with PC_ID replaced by PC_PLRS_ID.

In a variant example 3.3.8.1, the list of PC_PLRS_IDs and TCI state IDs is included in a DCI format.

In one example 3.3.9, a list of ULParam_IDs is included in the MAC CE, wherein a first ULParam_ID is associated with a first TCI state ID (e.g., lowest activated TCI State ID), a next second ULParam_ID is associated with a second TCI state ID (e.g., a second lowest activated TCI State ID). This is similar to FIG. 30 with PC_ID replaced by ULParama_ID.

In a variant example 3.3.9.1, the list of ULParam_IDs is included in a DCI Format.

In one example 3.3.10, a list of ULParam_IDs and activated TCI state IDs is included in the MAC CE. This is similar to FIG. 31 with PC_ID replaced by ULParam_ID.

In a variant example 3.3.10.1, the list of ULParam_IDs and TCI state IDs is included in a DCI format.

In one example 3.3.11, a list of ULParam_IDs and PLRS_IDs is included in the MAC CE, wherein a first ULParam_ID and PLRS_ID is associated with a first TCI state ID (e.g., lowest activated TCI State ID), a next second ULParam_ID and PLRS_ID is associated with a second TCI state ID (e.g., a second lowest activated TCI State ID). This is similar to FIG. 32 with PC_ID replaced by ULParam_ID.

In a variant example 3.3.11.1, the list of ULParam_IDs and PLRS_IDs is included in a DCI format.

In one example 3.3.12, a list of ULParam_IDs and PLRS_IDs and activated TCI state IDs is included in the MAC CE. This is similar to FIG. 33 with PC_ID replaced by ULParam_ID.

In a variant example 3.3.12.1, the list of ULParam_IDs and PLRS_IDs and TCI state IDs is included in a DCI format.

In one example 3.3.13, a list of ULParam_PLRS_IDs is included in the MAC CE, wherein a first ULParam_PLRS_ID is associated with a first TCI state ID (e.g., lowest activated TCI State ID), a next second ULParam_PLRS_ID is associated with a second TCI state ID (e.g., a second lowest activated TCI State ID). This is similar to FIG. 30 with PC_ID replaced by ULParam_PLRS_ID.

In a variant example 3.3.13.1, the list of ULParam_PLRS_IDs is included in a DCI format.

In one example 3.3.14, a list of ULParam_PLRS_IDs and activated TCI state IDs is included in the MAC CE. This is similar to FIG. 31 with PC_ID replaced by ULParam_PLRS_ID.

In a variant example 3.3.14.1, the list of ULParam_PLRS_IDs and TCI state IDs is included in a DCI format.

In one example 3.3.15, TABLE 1 to TABLE 5, as applicable, can be common to all uplink channels and signals (e.g., PUSCH, PUCCH and SRS) and hence a common ID(s), for each active TCI state, is included in the MAC CE PDU or DCI. In a further example, an additional channel specific component can be applied as described in component 2 (e.g., FIG. 13).

In another example 3.3.15, TABLE 1 to TABLE 5, as applicable, can be configured to one or more uplink channels and signals (e.g., PUSCH, PUCCH or SRS). For example: (1) one table configured for PUSCH and/or one table configured for PUCCH and/or one table configured for SRS; (2) one table configured for PUSCH and PUCCH and/or one table configured for SRS; (3) one table configured for PUSCH and SRS and/or one table configured for PUCCH; and/or (4) one table configured for PUCCH and SRS and/or one table configured for PUSCH.

In one example 3.3.15.1, separate IDs, for each active TCI state, are included in the MAC CE PDU or DCI, one associated with each configured table.

In another example 3.3.15.2, a common ID(s), for each active TCI state, is included in the MAC CE PDU or DCI. The common ID(s) points to an entry with the same ID in each of the configured tables.

In another example 3.4, the network configures the association between a PC_ID and/or a PLRS_ID and/or PC_PLRS_ID and/or ULParam_ID and/or ULParam_PLRS_ID, wherein PC_ID, a PLRS_ID, PC_PLRS_ID, ULParam_ID and ULParam_PLRS_ID are as described in TABLE 1 to TABLE 5, and the activated TCI states by RRC signaling. This is illustrated in TABLE 6.

TABLE 6

| Activated TCI | PC_ID and/or PLRS_ID and/or PC_PLRS_ID |
|---|---|
| state (codepoint) | and/or ULParam_ID and/or ULParam_PLRS_ID |
| 0 | Corresponding PC_ID and/or PLRS_ID and/or |
| | PC_PLRS_ID and/or ULParam_ID and/or |
| | ULParam_PLRS_ID |
| 1 | Corresponding PC_ID and/or PLRS_ID and/or |
| | PC_PLRS_ID and/or ULParam_ID and/or |
| | ULParam_PLRS_ID |
| . . . | . . . |
| | Corresponding PC_ID and/or PLRS_ID and/or |
| | PC_PLRS_ID and/or ULParam_ID and/or |
| | ULParam_PLRS_ID |

In one example 3.4.1, TABLE 1 to TABLE 6, as applicable, can be common to all uplink channels and signals (e.g., PUSCH, PUCCH and SRS) and hence a common ID(s) are determined for each active TCI state. In a further example, an additional channel specific component can be applied as described in component 2 (e.g., FIG. 13).

In another example 3.4.2, TABLE 1 to TABLE 5, can be configured for one or more uplink channels and signals (e.g., PUSCH, PUCCH or SRS). For example: (1) one table configured for PUSCH and/or one table configured for PUCCH and/or one table configured for SRS; (2) one table configured for PUSCH and PUCCH and/or one table configured for SRS; (3) one table configured for PUSCH and SRS and/or one table configured for PUCCH; and/or (4) one table configured for PUCCH and SRS and/or one table configured for PUSCH.

In one example 3.4.2.1, separate IDs, are determined, i.e., TABLE 6 is configured separately for each uplink channel or signal (e.g., PUSCH, PUCCH and SRS).

In another example 3.4.2.2, a common ID(s), is determined for all the uplink channels or signal s (e.g., PUSCH, PUCCH and SRS) for each active TCI state. The common ID(s) points to an entry with the same ID in each of the configured TABLE 1 to TABLE 5.

In another example 3.5, the network configures the association between a PC_ID and/or a PLRS_ID and/or PC_PLRS_ID and/or ULParam_ID and/or ULParam_PLRS_ID, wherein PC_ID, a PLRS_ID, PC_PLRS_ID, ULParam_ID and ULParam_PLRS_ID are as described in TABLE 1 to TABLE 5, and the configured TCI states by RRC signaling. This is illustrated in TABLE 7.

TABLE 7

| Configured | PC_ID and/or PLRS_ID and/or PC_PLRS_ID |
|---|---|
| TCI State | and/or ULParam_ID and/or ULParam_PLRS_ID |
| 0 | Corresponding PC_ID and/or PLRS_ID and/or |
| | PC_PLRS_ID and/or ULParam_ID and/or |
| | ULParam_PLRS_ID |
| 1 | Corresponding PC_ID and/or PLRS_ID and/or |
| | PC_PLRS_ID and/or ULParam_ID and/or |
| | ULParam_PLRS_ID |
| . . . | . . . |
| | Corresponding PC_ID and/or PLRS_ID and/or |
| | PC_PLRS_ID and/or ULParam_ID and/or |
| | ULParam_PLRS_ID |

In one example 3.5.1, TABLE 1 to TABLE 5 and TABLE 7, as applicable, can be common to all uplink channels and signals (e.g., PUSCH, PUCCH and SRS) and hence a common ID(s) are determined for each configured TCI state. In a further example, an additional channel specific component can be applied as described in component 2 (e.g., FIG. 13).

In another example 3.5.2, TABLE 1 to TABLE 5, as applicable, can be configured for one or more uplink channels and signals (e.g., PUSCH, PUCCH or SRS). For example: (1) one table configured for PUSCH and/or one table configured for PUCCH and/or one table configured for SRS; (2) one table configured for PUSCH and PUCCH and/or one table configured for SRS; (3) one table configured for PUSCH and SRS and/or one table configured for PUCCH; and/or (4) one table configured for PUCCH and SRS and/or one table configured for PUSCH.

In one example 3.5.2.1, separate IDs, are determined, i.e., TABLE 7 is configured separately for each uplink channel or signal (e.g., PUSCH, PUCCH and SRS).

In another example 3.5.2.2, a common ID(s), is determined for all the uplink channels or signal s (e.g., PUSCH, PUCCH and SRS) for each configured TCI state. The common ID(s) points to an entry with the same ID in each of the configured TABLE 1 to TABLE 5.

In one example 3.6, the indication of a TCI state to the UE, wherein the indication of the TCI state can be by: (1) a DCI format that includes a beam indication(s), e.g., DL related DCI format (e.g., DCI Format 1_0 or DCI Format 1_1 or DCI Format 1_2 with or without a DL assignment), UL related DCI format (e.g., DCI Format 0_0 or DCI Format 0_1 or DCI Format 0_2 with or without a UL grant), or a purpose designed DCI Format for beam indication; and/or (2) a MAC CE that includes a beam indication(s), is an indication of the PL RS included in or associated with the TCI state. The UE applies the PL RS in response to the TCI state indication.

In one example 3.6.1, the beam application time of the source RS of the UL and/or DL spatial filter and the application time of the PL RS are the same. Wherein the application time can be measured from one of: (1) the channel (DCI Format or MAC CE) containing the TCI state indication; and/or (2) the acknowledgment (e.g., HARQ-ACK) to the channel (DCI Format or MAC CE) containing the TCI state indication.

In a further example, the application time can be configured and/or updated by RRC signaling and/or MAC CE signaling and/or L1 control signaling. The application time can further depend on a UE capability. The application time can further depend on the sub-carrier spacing of the channel including the TCI state(s) and/or the channel(s) to which the TCI state(s) is being applied and/or the PL RS (e.g., based on the smallest (or largest) sub-carrier spacing among these channels and/or signals or a subset of them).

In another example 3.6.2, the beam application time of the source RS of the UL and/or DL spatial filter and the application time of the PL RS are different. Wherein the application times can be measured from one of: (1) the channel (DCI Format or MAC CE) containing the TCI state indication; and/or (2) the acknowledgment (e.g., HARQ-ACK) to the channel (DCI Format or MAC CE) containing the TCI state indication.

In a further example, the application times can be configured and/or updated by RRC signaling and/or MAC CE signaling and/or L1 control signaling. The application times can further depend on a UE capability. The application times can further depend on the sub-carrier spacing of the channel including the TCI state(s) and/or the channel(s) to which the TCI state(s) is being applied and/or the PL RS (e.g., based on the smallest (or largest) sub-carrier spacing among these channels and/or signals or a subset of them).

In one example 3.6a, the indication of a TCI state to the UE, is applied to multiple component carriers, wherein the indication of the TCI state can be by: (1) a DCI Format that includes a beam indication(s), e.g., DL related DCI format (e.g., DCI Format 1_0 or DCI Format 1_1 or DCI Format 1_2 with or without a DL assignment), UL related DCI format (e.g., DCI format 0_0 or DCI format 0_1 or DCI format 0_2 with or without a UL grant), or a purpose designed DCI format for beam indication; and/or (2) a MAC CE that includes a beam indication(s), is an indication of the PL RS included in or associated with the TCI state. The UE applies the PL RS in response to the TCI state indication.

In one example 3.6a.1, a common source RS of the UL and/or DL spatial filter is determined for all component carriers.

In another example 3.6a.2, a source RS of the UL and/or DL spatial filter is determined for each component carrier.

In another example 3.6a.3, the component carriers are partitioned into sub-sets and a source RS of the UL and/or DL spatial filter is determined for each subset.

In one example 3.6a.4, a common PLRS is determined for all component carriers.

In another example 3.6a.5, a PLRS is determined for each component carrier.

In another example 3.6a.6, the component carriers are partitioned into sub-sets and a PLRS is determined for each subset.

In one example 3.6a.7, the beam application time of the source RS of the UL and/or DL spatial filter and the application time of the PL RS are the same.

In one example 3.6a.7.1, the beam application time of the source RS of the UL and/or DL spatial filter and the application time of the PL RS are the same across all component carriers.

In one example 3.6a.7.2, the beam application time of the source RS of the UL and/or DL spatial filter and the application time of the PL RS are the same for each component carrier, but can be different for different component carriers.

In one example 3.6a.7.3, the beam application time of the source RS of the UL and/or DL spatial filter and the application time of the PL RS are the same across a subset of component carriers but can be different for different subsets of component carriers. Wherein the application time can be measured from one of: (1) the channel (DCI format or MAC CE) containing the TCI state indication; and/or (2) the acknowledgment (e.g., HARQ-ACK) to the channel (DCI format or MAC CE) containing the TCI state indication.

In a further example, the application time can be configured and/or updated by RRC signaling and/or MAC CE signaling and/or L1 control signaling. The application time can further depend on a UE capability. The application time can further depend on the sub-carrier spacing of the channel including the TCI state(s) and/or the channel(s) to which the TCI state(s) is being applied and/or the PL RS (e.g., based on the smallest (or largest) sub-carrier spacing among these channels and/or signals or a subset of them).

In a further example, when the application time is the same across all component carriers or across a subset of component carriers, the application time is the maximum time across all component carriers or across a subset of component carriers respectively. For example, the application time can be determined (or configured) for each component carrier (e.g., based on sub-carrier spacing of the component carrier and other characteristics of the component carrier), the maximum application time is then determined across all component carriers or across a subset of component carriers, respectively, and is used as a common time for beam application and PLRS application across all the component carriers or across a subset of the component carriers respectively.

In another example 3.6a.8, the beam application time of the source RS of the UL and/or DL spatial filter and the application time of the PL RS are different.

In one example 3.6a.8.1, the beam application time of the source RS of the UL and/or DL spatial filter is the same across all component carriers.

In one example 3.6a.8.2, the beam application time of the source RS of the UL and/or DL spatial filter can be different for each component carrier.

In one example 3.6a.8.3, the beam application time of the source RS of the UL and/or DL spatial filter is the same across a subset of component carriers but can be different for different subsets of component carriers.

In one example 3.6a.8.4, the application time of the PL RS is the same across all component carriers.

In one example 3.6a.8.5, the application time of the PL RS can be different for each component carrier.

In one example 3.6a.8.6, the application time of the PL RS is the same across a subset of component carriers but can be different for different subsets of component carriers. Wherein the application times can be measured from one of: (1) the channel (DCI format or MAC CE) containing the TCI state indication; and/or (2) the acknowledgment (e.g., HARQ-ACK) to the channel (DCI format or MAC CE) containing the TCI state indication.

In a further example, the application times can be configured and/or updated by RRC signaling and/or MAC CE signaling and/or L1 control signaling. The application times can further depend on a UE capability. The application times can further depend on the sub-carrier spacing of the channel including the TCI state(s) and/or the channel(s) to which the TCI state(s) is being applied and/or the PL RS (e.g., based on the smallest (or largest) sub-carrier spacing among these channels and/or signals or a subset of them).

In a further example, when the application time is the same across all component carriers or across a subset of component carriers, the application time is the maximum time across all component carriers or across a subset of component carriers respectively. For example, the application time can be determined (or configured) for each component carrier (e.g., based on sub-carrier spacing of the component carrier and other characteristics of the component carrier), the maximum application time is then determined across all component carriers or across a subset of component carriers, respectively, and is used as a common time for beam application or PLRS application across all the component carriers or across a subset of the component carriers respectively.

In one example 3.7, a PC_ID and/or a PLRS_ID and/or PC_PLRS_ID and/or ULParam_ID and/or ULParam_PLRS_ID, wherein PC_ID, PLRS_ID, PC_PLRS_ID, ULParam_ID and ULParam_PLRS_ID are as described in TABLE 1 to TABLE 5 are independent of the TCI state.

In one example 3.7.1, TABLE 1 to TABLE 5, as applicable, can be common to all uplink channels and signals (e.g., PUSCH, PUCCH and SRS). For each UL channel or signal an entry in TABLE 1 to TABLE 5, if applicable, applies to that channel or signal. Wherein, the index of the entry for each UL channel and/or index is specified in the system specifications and/or configured RRC signaling and/or MAC CE signaling and/or L1 control (DCI) signaling. In one further example, TABLE 1 to TABLE 5, as applicable, contain a single entry. In one further example, TABLE 1 to TABLE 5, as applicable, contain a single entry for each UL channel or UL signal.

In one example 3.7.2, each of TABLE 1 to TABLE 5, as applicable, can be separately configure for one or a group of uplink channels and signals (e.g., PUSCH, PUCCH and SRS). For each UL channel or UL signal an entry in TABLE 1 to TABLE 5, if applicable, from the Table corresponding to that channel or signal, applies to that channel or signal. Wherein, the index of the entry for each UL channel and/or index is specified in the system specifications and/or configured by RRC signaling and/or MAC CE signaling and/or L1 control (DCI) signaling. In one further example, TABLE 1 to TABLE 5, as applicable, contain a single entry.

In one example 3.7.3, the index of the entry, common to all activated TCI states, from TABLE 1 to TABLE 5, as applicable, can be included in the MAC CE activating the TCI states for joint and/or separate TCI state indication.

In one example, the MAC CE includes one or more entries for PC_ID from TABLE 1 and/or one or more entries for PLRS_ID from TABLE 2 and/or one or more entries for PC_PLRS_ID from TABLE 3 and/or one or more entries for ULParam_ID from TABLE 4 and/or one or more entries for ULParam_PLRS_ID from TABLE 5.

In one example, MAC CE includes an UL channel or UL signal specific entry (PC_ID and/or PLRS_ID and/or PC_PLRS_ID and/or ULParam_ID and/or ULParam_PLRS_ID) for each UL channel and UL signal (e.g., PUSCH, PUCCH and SRS).

In another example, an entry, corresponding to an ID (or index) into TABLE 1 to TABLE 5, applies to more than one UL channel and/or UL signal.

In another example, an entry, corresponding to an ID (or index) into TABLE 1 to TABLE 5, applies to all UL channels and UL signals.

In one example 3.8, a PC_ID and/or a PLRS_ID and/or PC_PLRS_ID and/or ULParam_ID and/or ULParam_PLRS_ID, wherein PC_ID, PLRS_ID, PC_PLRS_ID, ULParam_ID and ULParam_PLRS_ID are as described in TABLE 1 to TABLE 5, can have different beam dependency for different UL channels and/or UL signals.

For none, one or more of UL channels and/or signals, the beam dependency of PC_ID and/or a PLRS_ID and/or PC_PLRS_ID and/or ULParam_ID and/or ULParam_PLRS_ID can follow the example, of TABLE 6 and/or TABLE 7, wherein the association of PC_ID and/or a PLRS_ID and/or PC_PLRS_ID and/or ULParam_ID and/or ULParam_PLRS_ID is with the activated TCI states (MAC CE-based TCI state activation).

For none, one or more of UL channels and/or signals, the beam dependency of PC_ID and/or a PLRS_ID and/or PC_PLRS_ID and/or ULParam_ID and/or ULParam_PLRS_ID can follow the example, of TABLE 6 an/or TABLE 7, wherein the association of PC_ID and/or a PLRS_ID and/or PC_PLRS_ID and/or ULParam_ID and/or ULParam_PLRS_ID is with the configured TCI states (RRC-based TCI state configuration).

For none, one or more of UL channels and/or signals, the beam dependency of PC_ID and/or a PLRS_ID and/or PC_PLRS_ID and/or ULParam_ID and/or ULParam_PLRS_ID can follow the example, of TABLE 6 and/or TABLE 7, wherein the PC_ID and/or a PLRS_ID and/or PC_PLRS_ID and/or ULParam_ID and/or ULParam_PLRS_ID is independent of the TCI state.

For component 4, a source reference signal is a reference signal that determines the spatial domain transmit filter or the spatial domain receive filter of a target channel or a target reference signal. A source reference signal is included in a TCI state with QCL type D or spatial relation, wherein the TCI state is indicated or configured for the target channel or the target reference signal.

In the present disclosure, a source reference signal is a direct QCL Type-D or spatial relation reference signal of a target channel or a target reference signal, if the source reference signal is a source reference signal of QCL Type-D or spatial relation associated with the TCI state indicated or configured for the target channel or the target reference signal.

In the present disclosure, a source reference signal is an indirect QCL Type-D or spatial relation reference signal of a target channel or a target reference signal, if the source reference signal is a direct QCL Type-D or spatial relation source reference signal to a second resource signal, and the second reference signal is a direct or indirect QCL Type-D or spatial relation source reference signal for the target channel or the target reference signal.

In the present disclosure, a root reference signal is a reference signal with no source reference signal.

Two reference signals and/or channels are said to be in the same QCL chain if two reference signals and/or channels have the same root reference signal as a direct QCL Type D or spatial relation reference signal or as an indirect QCL Type D or spatial relation reference signal.

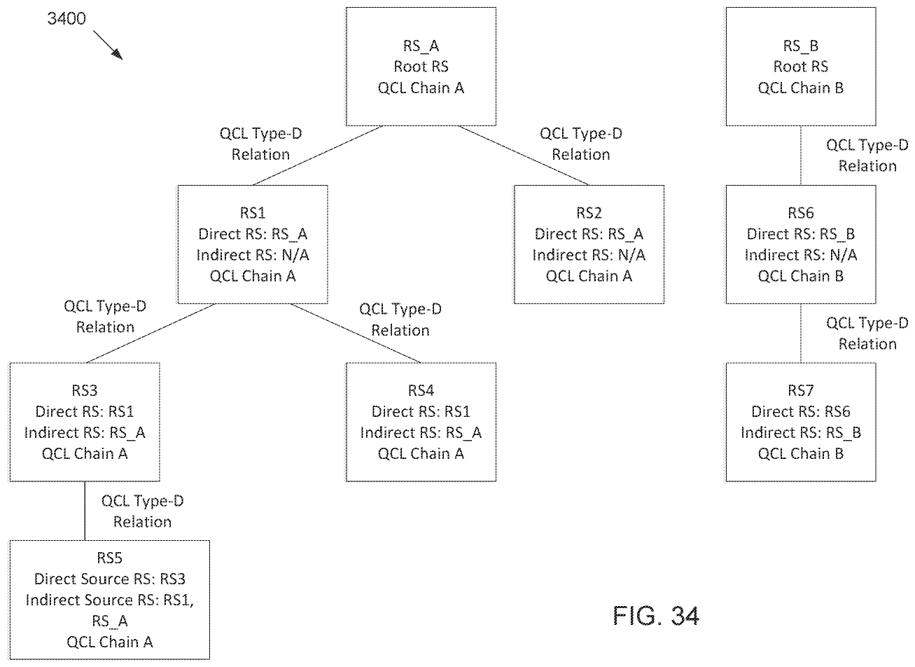

These definitions are illustrated by way of example in FIG. 34.

FIG. 34 illustrates an example of reference signals 3400 according to embodiments of the present disclosure. An embodiment of the reference signals 3400 shown in FIG. 34 is for illustration only.

In FIG. 34, there are two root reference signals, reference signal RS_A and reference signal RS_B.

In one example, reference signal RS_A. RS_A is associated with QCL chain A. RS_A is a direct QCL Type-D or spatial relation reference signal to: (1) reference signal RS1. RS1 is in QCL chain A. RS1 has RS_A as its direct QCL Type-D or spatial relation reference signal. RS1 doesn't have an indirect QCL Type-D or spatial relation reference signal. RS1 is a direct QCL Type-D or spatial relation reference signal to: (i) reference signal RS3. RS3 is in QCL chain A. RS3 has RS1 as its direct QCL Type-D or spatial relation reference signal. RS3 has RS_A as an indirect QCL Type-D or spatial relation reference signal. RS3 is a direct QCL Type-D or spatial relation reference signal to reference signal RS5. RS5 is in QCL chain A. RS5 has RS3 as its direct QCL Type-D or spatial relation reference signal. RS5 has RS_A and RS1 as indirect QCL Type-D or spatial relation reference signals; and (ii) reference signal RS4. RS4 is in QCL chain A. RS4 has RS1 as its direct QCL Type-D or spatial relation reference signal. RS4 has RS_A as an indirect QCL Type-D or spatial relation reference signal; and (iii) reference signal RS2. RS2 is in QCL chain A. RS2 has RS _A as its direct QCL Type-D or spatial relation reference signal. RS2 doesn't have an indirect QCL Type-D or spatial relation reference signal; (2) reference signal RS_B. RS_B is associated with QCL chain B. RS_B is a direct QCL Type-D or spatial relation reference signal to: (i) reference signal RS6. RS6 is in QCL chain B. RS6 has RS_B as its direct QCL Type-D or spatial relation reference signal. RS6 doesn't have an indirect QCL Type-D or spatial relation reference signal. RS6 is a direct QCL Type-D or spatial relation reference signal to reference signal RS7. RS7 is in QCL chain B. RS7 has RS6 as its direct QCL Type-D or spatial relation reference signal. RS7 has RS_B as an indirect QCL Type-D or spatial relation reference signal.

In example 4.1 to 4.16, a TCI state can be one of: (1) a UL TCI state and (2) a joint TCI state.

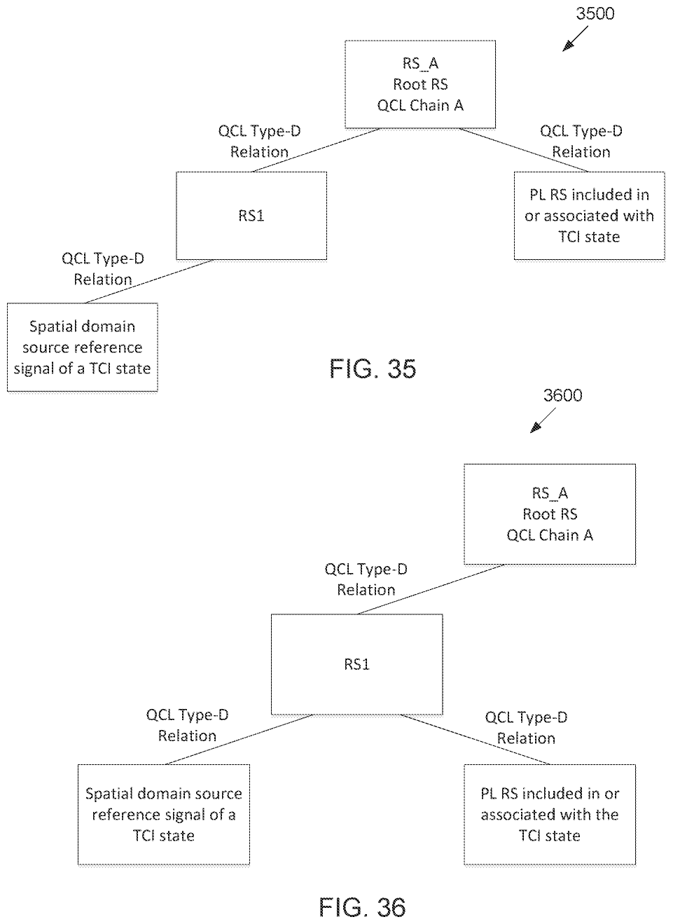

In one example 4.1, a spatial domain source reference signal of a TCI state and the corresponding PL RS included in or associated with the TCI state are configured to be in the same QCL chain. FIG. 35 is an illustration of this example.

FIG. 35 illustrates another example of reference signals 3500 according to embodiments of the present disclosure. An embodiment of the reference signals 3500 shown in FIG. 35 is for illustration only.

In another example 4.2, the UE is configured or signaled such that a spatial domain source reference signal of a TCI state and the corresponding PL RS included in or associated with the TCI state are in the same QCL chain. If the spatial domain source reference signal of the TCI state and the corresponding PL RS are not in the same QCL chain, it may depend on UE implementation how to measure the pathloss (e.g., which of the two RSes to select for pathloss measurement).

In another example 4.3, a spatial domain source reference signal of a TCI state and the corresponding PL RS included in or associated with the TCI state are the same reference signal.

In another example 4.4, the UE is configured or signaled such that a spatial domain source reference signal of a TCI state and the corresponding PL RS included in or associated with the TCI state are the same RS. If the spatial domain source reference signal of the TCI state and the corresponding PL RS are not the same RS, it may depend on UE implementation how to measure the pathloss (e.g., which of the two RSes to select for pathloss measurement).

In another example 4.5, a spatial domain source reference signal of a TCI state and the corresponding PL RS included in or associated with the TCI state have a same direct source reference signal. FIG. 36 is an illustration of this example.

FIG. 36 illustrates yet another example of reference signals 3600 according to embodiments of the present disclosure. An embodiment of the reference signals 3600 shown in FIG. 36 is for illustration only.

In another example 4.6, the UE is configured or signaled such that a spatial domain source reference signal of a TCI state and the corresponding PL RS included in or associated with the TCI state have the same direct source reference signal. If the spatial domain source reference signal of the TCI state and the corresponding PL RS do not have the same direct source reference signal, it may depend on UE implementation how to measure the pathloss (e.g., which of the two RSes to select for pathloss measurement).

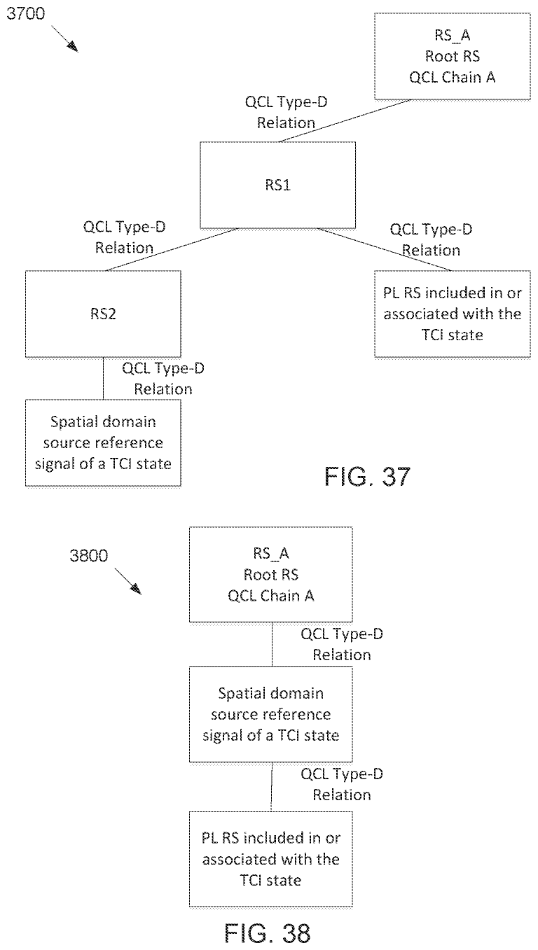

In another example 4.7, a spatial domain source reference signal of a TCI state and the corresponding PL RS included in or associated with the TCI state have a same direct or indirect source reference signal. FIG. 37 is an illustration of this example.

FIG. 37 illustrates another example of reference signals 3700 according to embodiments of the present disclosure. An embodiment of the reference signals 3700 shown in FIG. 37 is for illustration only.

In another example 4.8, the UE is configured or signaled such that a spatial domain source reference signal of a TCI state and the corresponding PL RS included in or associated with the TCI state have the same direct or indirect source reference signal. If the spatial domain source reference signal of the TCI state and the corresponding PL RS do not have the same direct or indirect source reference signal, it may depend on UE implementation how to measure the pathloss (e.g., which of the two RSes to select for pathloss measurement).

In another example 4.9, a spatial domain source reference signal of a TCI state and the corresponding PL RS included in or associated with the TCI state are such that the spatial domain source reference signal of a TCI state is a direct source reference signal for the PL RS included in or associated with the TCI state. FIG. 38 is an illustration of this example.

FIG. 38 illustrates an example of spatial domain source reference signal 3800 according to embodiments of the present disclosure. An embodiment of the spatial domain source reference signal 3800 shown in FIG. 38 is for illustration only.

In another example 4.10, the UE is configured or signaled such that a spatial domain source reference signal of a TCI state is a direct source reference signal for the PL RS included in or associated with the TCI state. If the spatial domain source reference signal of a TCI state is not a direct source reference signal for the PL RS included in or associated with the TCI state, it may depend on UE implementation how to measure the pathloss (e.g., which of the two RSes to select for pathloss measurement).

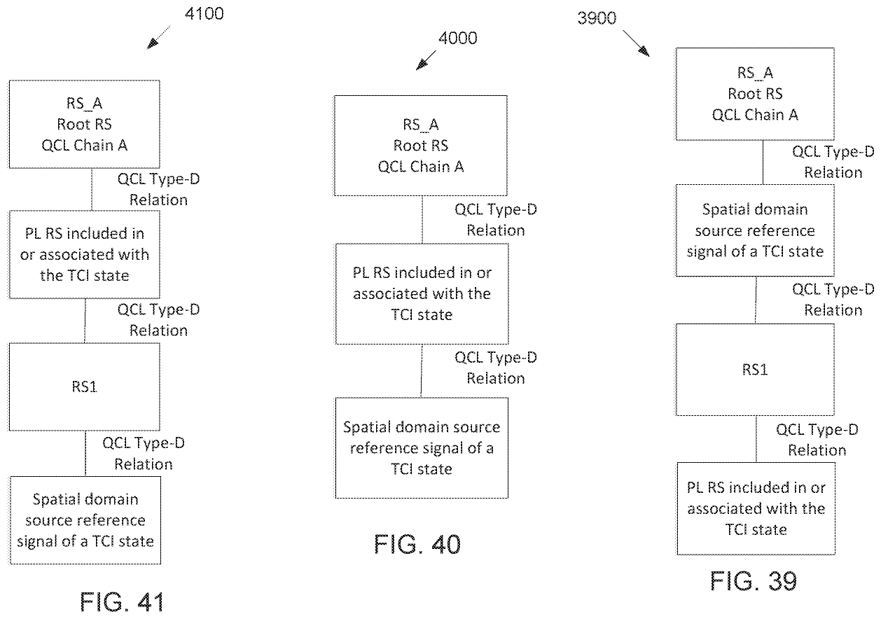

In another example 4.11, a spatial domain source reference signal of a TCI state and the corresponding PL RS included in or associated with the TCI state are such that the spatial domain source reference signal of a TCI state is a direct or indirect source reference signal for the PL RS included in or associated with the TCI state. FIG. 39 is an illustration of this example for the indirect case.

FIG. 39 illustrates another example of spatial domain source reference signal 3900 according to embodiments of the present disclosure. An embodiment of the spatial domain source reference signal 3900 shown in FIG. 39 is for illustration only.

In another example 4.12, the UE is configured or signaled such that a spatial domain source reference signal of a TCI state is a direct or indirect source reference signal for the PL RS included in or associated with the TCI state. If the spatial domain source reference signal of a TCI state is not a direct or indirect source reference signal for the PL RS included in or associated with the TCI state, it may depend on UE implementation how to measure the pathloss (e.g., which of the two RSes to select for pathloss measurement).

In another example 4.13, a PL RS included in or associated with the TCI state and a spatial domain source reference signal of the corresponding TCI state are such that the PL RS included in or associated with the TCI state is a direct source reference signal for the spatial domain source reference signal of the TCI state. FIG. 40 is an illustration of this example.

FIG. 40 illustrates yet another example of spatial domain source reference signal 4000 according to embodiments of the present disclosure. An embodiment of the spatial domain source reference signal 4000 shown in FIG. 40 is for illustration only.

In another example 4.14, the UE is configured or signaled such that a PL RS included in or associated with the TCI state is a direct source reference signal for the spatial domain source reference signal of the TCI state. If the PL RS included in or associated with the TCI state is not a direct source reference signal for the spatial domain source reference signal of the TCI state, it may depend on UE implementation how to measure the pathloss (e.g., which of the two RSes to select for pathloss measurement).

In another example 4.15, a PL RS included in or associated with the TCI state and a spatial domain source reference signal of the corresponding TCI state are such that the PL RS included in or associated with the TCI state is a direct or indirect source reference signal for the spatial domain source reference signal of the TCI state. FIG. 41 is an illustration of this example for the indirect case.

FIG. 41 illustrates yet another example of spatial domain source reference signal 4100 according to embodiments of the present disclosure. An embodiment of the spatial domain source reference signal 4100 shown in FIG. 41 is for illustration only.

In another example 4.16, the UE is configured or signaled such that a PL RS included in or associated with the TCI state is a direct or indirect source reference signal for the spatial domain source reference signal of the TCI state. If the PL RS included in or associated with the TCI state is not a direct or indirect source reference signal for the spatial domain source reference signal of the TCI state, it may depend on UE implementation how to measure the pathloss (e.g., which of the two RSes to select for pathloss measurement).

In one example 4.17, an SRS resource set includes more than one SRS resource.

In one example 4.17.1, each SRS resource has: (1) a separate spatial domain source reference signal; and/or (2) a separate PL RS.

The spatial domain source reference signal and the PL RS follows one of the examples of 4.1 to 4.16.

In another example 4.17.2, each SRS resource has a separate spatial domain source reference signal.

The PL RS is common for the SRS resources of the SRS resource set. The PL RS can be a direct or indirect Type-D or spatial relation reference signal to the spatial domain source reference signal of each SRS resource. In one further example, if the PL RS is not a direct or indirect Type-D reference signal to the spatial domain source reference signal of each SRS resource, it may depend on UE implementation how to measure the pathloss (e.g., which of the two RSes to select for pathloss measurement for an SRS resource).

In one further example 4.17.2.1, SRS resource set Y includes N SRS resources {X₀, X₁, . . . , X_{N-1}}, wherein SRS resource Xᵢ can be configured, activated or indicated a TCI state TCIᵢ, wherein the TCI state can be a UL TCI state or a Joint TCI state. In case of a joint beam for DL and UL channels/signals, a joint TCI state is configured, activated or indicated to the UE for downlink and uplink channels/signals. In case of separate beam for DL and UL channels/signals, a DL TCI state is configured, activated or indicated to the UE for DL channels/signals and a UL TCI state is configured, activated or indicated to the UE for UL channels/signals.

In one example 4.17.2.1.1, the TCI states TCIᵢ for i=0 . . . N−1 are associated with the same PL-RS. i.e., the TCI states of the SRS resources in a same SRS resource set are associated to the same PL-RS. In one example, this can be by gNB/Network implementation. In one example, a UE expects that the PL-RS associated with a TCI state of an SRS resource is the same for all SRS resources in the same SRS resource set.

In one example 4.17.2.1.2, the TCI states TCIᵢ for i=0 . . . N−1 include the same PL-RS. i.e., the TCI states of the SRS resources in a same SRS resource set include the same PL-RS. In one example, this can be by gNB/Network implementation. In one example, a UE expects that the PL-RS included in a TCI state of an SRS resource is the same for all SRS resources in the same SRS resource set.

In one example 4.17.2.1.3, the TCI states TCI for i=0 . . . N−1 are associated with the same UL power control (PC) parameters for SRS (e.g., P0, alpha, closed loop index). i.e., the TCI states of the SRS resources in a same SRS resource set are associated to the same UL PC parameters for SRS. In one example, this can be by gNB/Network implementation. In one example, a UE expects that the UL PC parameters for SRS associated with a TCI state of an SRS resource is the same for all SRS resources in the same SRS resource set.

In one example 4.17.2.1.4, the TCI states TCIᵢ for i=0 . . . N−1 include the same UL power control (PC) parameters for SRS (e.g., P0, alpha, closed loop index). i.e., the TCI states of the SRS resources in a same SRS resource set include the same UL PC parameters for SRS. In one example, this can be by gNB/Network implementation. In one example, a UE expects that the UL PC parameters for SRS included in a TCI state of an SRS resource is the same for all SRS resources in the same SRS resource set.

In one example 4.17.2.1.5, the PL-RS for SRS resources Xᵢ in a same SRS resource set, i=0 . . . N−1, is determined such that the PL-RS for any SRS resource is determined by the PL-RS associated with TCI state TCIₘ of SRS resource Xₘ, where 0≤m<N. In one example, m is specified in the system specification; in one sub-example m=0, in another sub-example m=N−1; in one sub-example m corresponds to the SRS resource with the lowest SRS resource ID in the SRS resource set; in one sub-example m corresponds to the SRS resource with the highest SRS resource ID in the SRS resource set. In another example, m is configured and/or updated by RRC signaling and/or MAC CE signaling and/or L1 control signaling. In one sub-example, m is included in the SRS resource set configuration.

In one example 4.17.2.1.6, the PL-RS for SRS resources Xᵢ in a same SRS resource set, i=0 . . . N−1, is determined such that the PL-RS for any SRS resource is determined by the PL-RS included in TCI state TCIₘ of SRS resource Xₘ, where 0≤m<N. In one example, m is specified in the system specification; in one sub-example m=0, in another sub-example m=N−1; in one sub-example m corresponds to the SRS resource with the lowest SRS resource ID in the SRS resource set; in one sub-example m corresponds to the SRS resource with the highest SRS resource ID in the SRS resource set. In another example, m is configured and/or updated by RRC signaling and/or MAC CE signaling and/or L1 control signaling. In one sub-example, m is included in the SRS resource set configuration.

In one example 4.17.2.1.7, the UL power control (PC) parameters for SRS (e.g., P0, alpha, closed loop index) for SRS resources Xᵢ in a same SRS resource set, i=0 . . . N−1, is determined such that the UL PC parameters for any SRS resource is determined by the UL PC parameters for SRS associated with TCI state TCIₘ of SRS resource Xₘ, where 0≤m<N. In one example, m is specified in the system specification; in one sub-example m=0, in another sub-example m=N−1; in one sub-example m corresponds to the SRS resource with the lowest SRS resource ID in the SRS resource set; in one sub-example m corresponds to the SRS resource with the highest SRS resource ID in the SRS resource set. In another example, m is configured and/or updated by RRC signaling and/or MAC CE signaling and/or L1 control signaling. In one sub-example, m is included in the SRS resource set configuration.

In one example 4.17.2.1.8, the UL power control (PC) parameters for SRS (e.g., P0, alpha, closed loop index) for SRS resources Xᵢ in a same SRS resource set, i=0 . . . N−1, is determined such that the UL PC parameters for any SRS resource is determined by the UL PC parameters for SRS included in TCI state TCIₘ of SRS resource Xₘ, where 0≤m<N. In one example, m is specified in the system specification; in one sub-example m=0, in another sub-example m=N−1; in one sub-example m corresponds to the SRS resource with the lowest SRS resource ID in the SRS resource set; in one sub-example m corresponds to the SRS resource with the highest SRS resource ID in the SRS resource set. In another example, m is configured and/or updated by RRC signaling and/or MAC CE signaling and/or L1 control signaling. In one sub-example, m is included in the SRS resource set configuration.

In one example 4.17.2.1.9, the association of a same PL-RS or UL PC parameters to SRS resources in a same SRS resource set is for SRS resources that don't follow the unified or master or main TCI state of UE-dedicated channels.

In one example 4.17.2.1.10, if one or more SRS resources in the SRS resource set follow the unified (or master or main) TCI state, the PL-RS of any SRS resource (even if one or more SRS resources does not follow the unified (master or main) TCI state) in the SRS resource set is that associated with the unified (or master or main) TCI state.

In one example 4.17.2.1.11, if one or more SRS resources in the SRS resource set follow the unified (or master or main) TCI state, the PL-RS of any SRS resource (even if one or more SRS resources does not follow the unified (master or main) TCI state) in the SRS resource set is that included in the unified (or master or main) TCI state.

In one example 4.17.2.1.12, if one or more SRS resources in the SRS resource set follow the unified (or master or main) TCI state, the UL power control (PC) parameters of any SRS resource (even if one or more SRS resources does not follow the unified (master or main) TCI state) in the SRS resource set is that associated with the unified (or master or main) TCI state.

In one example 4.17.2.1.13, if one or more SRS resources in the SRS resource set follow the unified (or master or main) TCI state, the UL power control (PC) parameters of any SRS resource (even if one or more SRS resources does not follow the unified (master or main) TCI state) in the SRS resource set is that included in the unified (or master or main) TCI state.

In another example 4.17.3, each SRS resource has a separate PL RS.

The spatial domain source reference signal is common for the SRS resources of the SRS resource set. The spatial domain source reference signal can be a direct or indirect Type-D or spatial relation reference signal to the PL RS of each SRS resource. In one further example, if the spatial domain source reference signal is not a direct or indirect Type-D or spatial relation reference signal to the PL RS of each SRS resource, it may depend on UE implementation how to measure the pathloss (e.g., which of the two RSes to select for pathloss measurement for an SRS resource).

In one example 4.17.4, the SRS resource set is configured by: (1) a common spatial domain source reference signal for all SRS resources of the SRS resource set; and/or (2) a common PL RS for all SRS resources of the SRS resource set.

The spatial domain source reference signal and the PL RS follows one of the examples of 4.1 to 4.16.

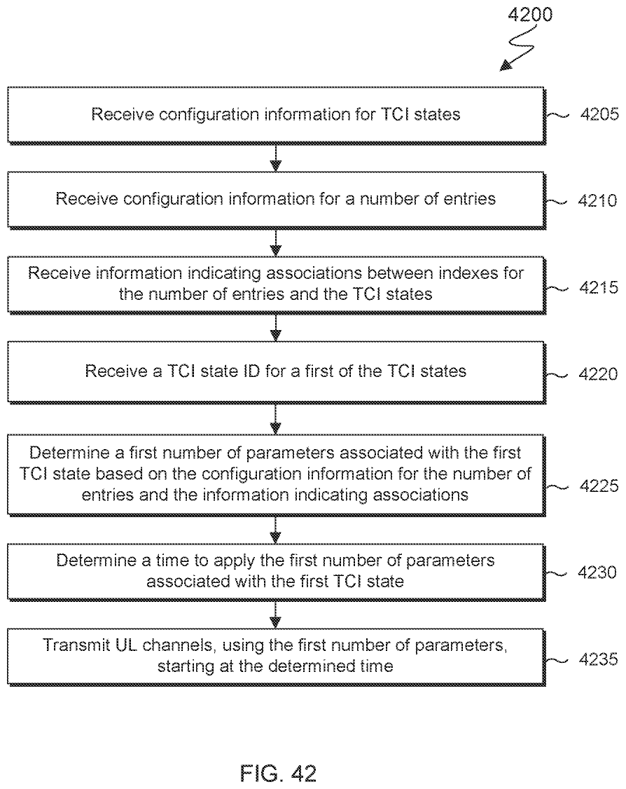

FIG. 42 illustrates a flowchart for a method 4200 for indication of UL parameters in a TCI state according to embodiments of the present disclosure. For example, the method 4200 as may be performed by a UE (e.g., 111-116 as illustrated in FIG. 1) and a complementary method may be performed by a BS (e.g., BS 101-103 as illustrated in FIG. 1). An embodiment of the method 4200 shown in FIG. 42 is for illustration only. One or more of the components illustrated in FIG. 42 can be implemented in specialized circuitry configured to perform the noted functions or one or more of the components can be implemented by one or more processors executing instructions to perform the noted functions.

The method starts with the UE receiving configuration information for TCI states (step 4205). The UE then receives configuration information for a number of entries (step 4210). In step 4210, each of the number of entries includes an index and a number of parameters. The number of entries include may include a first number of entries configured for a PUSCH, a second number of entries configured for a PUCCH, and a third number of entries configured for a SRS. Each entry may include power control parameters (e.g., P0, alpha, and/or Power Control Closed Loop Index) and/or PL-RS and/or UL time advance. A separate number of entries can be configured for power control parameters and/or PL-RS and/or UL time advance.

The UE receives information indicating associations between indexes for the number of entries and the TCI states, respectively (step 4215). The UE then receives a TCI state ID for a first of the TCI states (step 4220). In step 4220, a PLRS may be included in the first TCI state or associated with the first TCI state. Alternatively, a Type-D QCL source reference signal included in the first TCI state is used as a pathloss reference signal. The Type-D QCL or spatial relation source reference signal is one of a SSB or a NZP CSI-RS.

The UE determines a first number of parameters associated with the first TCI state based on the configuration information for the number of entries and the information indicating associations (step 4225). In step 4225, the first number of parameters may include at least one of P0 for a PUSCH, a PUCCH, or a SRS, a power control parameter alpha, and a closed power control loop index. The first number of parameters may also include an UL time advance.

The UE then determines a time to apply the first number of parameters associated with the first TCI state (step 4230). The UE transmits UL channels, using the first number of parameters, starting at the determined time (step 4235). In step 4235, the UE may apply a pathloss estimation based on the PLRS included in or associated with the first TCI state starting at a same time as a UL spatial domain filter determined based on when the first TCI state is applied for transmission of the UL channels.

The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A user equipment (UE), comprising:
a transceiver configured to receive:
configuration information for transmission configuration information (TCI) states,
configuration information for a number of entries, wherein each of the number of entries includes an index and a number of parameters,
information indicating associations between indexes for the number of entries and the TCI states, respectively, and
a TCI state identifier (ID) for a first of the TCI states; and
a processor operably coupled to the transceiver, the processor configured to:
determine a first number of parameters associated with the first TCI state based on the configuration information for the number of entries and the information indicating associations, and
determine a time to apply the first number of parameters associated with the first TCI state,
wherein the transceiver is further configured to transmit uplink (UL) channels, using the first number of parameters, starting at the determined time.

2. The UE of claim 1, wherein the first number of parameters includes at least one of:
P0 for a physical uplink shared channel (PUSCH), a physical uplink control channel (PUCCH), or a sounding reference (SRS),
a power control parameter alpha, and
a power control closed loop index.

3. The UE of claim 1, wherein the first number of parameters includes an UL time advance.

4. The UE of claim 1, wherein the number of entries include:
a first number of entries configured for a physical uplink shared channel (PUSCH),
a second number of entries configured for a physical uplink control channel (PUCCH), and
a third number of entries configured for a sounding reference (SRS).

5. The UE of claim 1, wherein a pathloss reference signal (PLRS) is included in the first TCI state.

6. The UE of claim 5, wherein the UE is configured to apply a pathloss estimation based on the PLRS included in the first TCI state starting at a same time as a UL spatial domain filter determined based on when the first TCI state is applied for transmission of the UL channels.

7. The UE of claim 1, wherein:
a Type-D quasi-co-location (QCL) or spatial relation source reference signal included in the first TCI state is used as a pathloss reference signal, and
the Type-D QCL or spatial relation source reference signal is one of a synchronization signal/physical broadcast channel (PBCH) block (SSB) or a periodic non-zero power channel state information-reference signal (NZP CSI-RS).

8. A base station (BS), comprising:
a transceiver configured to transmit:
configuration information for transmission configuration information (TCI) states,
configuration information for a number of entries, wherein each of the number of entries includes an index and a number of parameters,
information indicating associations between indexes for the number of entries and the TCI states, respectively, and
a TCI state identifier (ID) for a first of the TCI states; and
a processor operably coupled to the transceiver, the processor configured to:
determine a first number of parameters associated with the first TCI state, and
determine a time to apply the first number of parameters associated with the first TCI state,
wherein the transceiver is further configured to receive UL channels, based on the first number of parameters, starting at the determined time.

9. The BS of claim 8, wherein the first number of parameters includes at least one of:
P0 for a physical uplink shared channel (PUSCH), a physical uplink control channel (PUCCH), or a sounding reference (SRS),
a power control parameter alpha, and
a power control closed loop index.

10. The BS of claim 8, wherein the first number of parameters includes an UL time advance.

11. The BS of claim 8, wherein the number of entries include:
a first number of entries is configured for a physical uplink shared channel (PUSCH),
a second number of entries is configured for a physical uplink control channel (PUCCH), and
a third number of entries is configured for a sounding reference (SRS).

12. The BS of claim 8, wherein a pathloss reference signal (PLRS) is included in the first TCI state.

13. The BS of claim 12, wherein a pathloss estimation based on the PLRS included in the first TCI state is applied starting at a same time an UL spatial domain filter determined based on when the first TCI state is applied for reception of the UL channels.

14. The BS of claim 8, wherein:
a Type-D quasi-co-location (QCL) or spatial relation source reference signal included in the first TCI state, is used as a pathloss reference signal, and
the Type-D QCL or spatial relation source reference signal is one of a synchronization signal/physical broadcast channel (PBCH) block (SSB) or a periodic non-zero power channel state information-reference signal (NZP CSI-RS).

15. A method of operating a user equipment (UE), comprising:
receiving configuration information for transmission configuration information (TCI) states;
receiving configuration information for a number of entries, wherein each of the number of entries includes an index and a number of parameters;
receiving information indicating associations between indexes for the number of entries and the TCI states, respectively;
receiving a TCI state identifier (ID) for a first of the TCI states;
determining a first number of parameters associated with the first TCI state based on the configuration information for the number of entries and the information indicating associations;
determining a time to apply the first number of parameters associated with the first TCI state; and
transmitting uplink (UL) channels, using the first number of parameters, starting at the determined time.

16. The method of claim 15, wherein the first number of parameters includes at least one of:
P0 for a physical uplink shared channel (PUSCH), a physical uplink control channel (PUCCH), or sounding reference (SRS),
a power control parameter alpha, and
a power control closed loop index.

17. The method of claim 15, wherein the first number of parameters includes an UL time advance.

18. The method of claim 15, wherein the number of entries include:
a first number of entries is configured for a physical uplink shared channel (PUSCH),
a second number of entries is configured for a physical uplink control channel (PUCCH), and
a third number of entries is configured for a sounding reference (SRS).

19. The method of claim 15, wherein a pathloss reference signal (PLRS) is included in the first TCI state.

20. The method of claim 19, further comprising applying a pathloss estimation based on the PLRS included in the first TCI state starting at a same time as an UL spatial domain filter determined based on when the first TCI state is applied for transmission of the UL channels.
